(19) United States
(12) Patent Application Publication
(10) Pub. No.: US 2002/0099829 A1
(43) Pub. Date: Jul. 25, 2002

(54) Filter proxy system and method

(76) Inventors: Kenneth W. Richards, Richfield, MN (US); Charles William Frank, Plymouth, MN (US); David Vincent Duccini, St. Paul, MN (US)

Correspondence Address: MERCHANT & GOULD PC, P.O. BOX 2903, MINNEAPOLIS, MN, 55402-0903, US

(21) Appl. No.: 09/776,609

(22) Filed: Feb. 2, 2001

Related U.S. Application Data
(60) Provisional application No. 60/253,195, filed on Nov. 27, 2000.

(51) Int. Cl. G06F 15/16

(52) U.S. Cl. 709/227; 709/228

(57) ABSTRACT

The present invention relates to a filter proxy system and method, more particularly, to a filter proxy system and method for re-authoring, re-purposing, and/or compressing content control languages, text, images, and/or other content for delivery and/or interaction with devices of varying, type, capacity, and/or bandwidth availability without operator's intervention, and interaction with other systems having an implementation of the same filter proxy systems for reducing bandwidth utilization between each other and distributing the processing of the content control language, and/or images, and/or other content for delivery of and/or interaction with devices of varying capacity and/or bandwidth availability without operator's intervention.

### RELATED APPLICATION

This application claims the benefit of Provisional Application, U.S. Serial No. 60/253,195, filed on Nov. 27, 2000, entitled “IMAGE FILTER PROXY”, by Kenneth W. Richards and Charles W. Frank.

### TECHNICAL FIELD

The present invention relates to a filter proxy system and method, more particularly, to a filter proxy system for comprehensive content acceleration and automated content formatting and method for re-authoring, re-purposing, and/or compressing content control languages, text, images, and/or other content for delivery and/or interaction with devices of varying, type, capacity, and/or bandwidth availability without operator's intervention, and interaction with other systems having same filter proxy systems for reducing bandwidth utilization between each other and a requesting device, and distributing the re-authoring, re-purposing, and compression processing of the content control language, and/or images, and/or other content for delivery of and/or interaction with devices of varying capacity and/or bandwidth availability without operator's intervention.

### BACKGROUND OF THE INVENTION

In the recent years, Internet technology has been developed rapidly, particularly in the areas of increasing speed of communication media, reducing bandwidth requirements for content movement, and increasing speed of access to resources on the network. However, there are few technologies focusing on solutions to bandwidth usage and control when transmitting control code, images, and/or text, and other content over local or wide area networks, wired or wireless communications media interacting across networks to coordinate bandwidth management from source to rendering device, content re-purposing for device specific requirements, and the processes involved therein.

One issue is related to access to the World Wide Web (WWW) or other Internet/Intranet network site by devices of limited capability, different operating systems, limited or constrained bandwidth whether the devices are on a wired or wireless network. Devices vary from having no capability to render images to those having full capability to render color images. Operating systems, applications, and memory restrictions vary from one device to another. These variations further restrict rendering capability, functional capability, and interaction with an original content when served on a WWW site to a device with limited rendering and viewing capabilities. Current methods of overcoming these restrictions are to statically and manually re-author each page and/or re-purpose each image individually for each specific device.

In other words, when an image/text content on a WWW or other Internet/Intranet network site is requested to be downloaded on a receiving device, the image/text content may have to be changed to meet a receiving device's specifications/requirements. Receiving devices are often of different types with different specifications/requirements. For example, receiving devices may have limited image/text capability, different operating systems, limited or constrained bandwidth, etc. Accordingly, image/text content designers have to review, and often times have to change the image/text content, when the image/text content is sent to a different receiving device. In the existing methods, each page of text content for each specific device is statically and manually re-authored. Further, each image of the WWW page content may need to be individually re-purposed for each specific device to a different file type and saved. Furthermore, when the size of an image/text is too large to fit a receiving device, the image/text must be manually re-sized and saved consuming disk space. Typically, in the existing methods, of re-authoring control language such as HTML, re-purposing of images and the compression process thereof is performed statically and manually for each specific device. As a result, the existing methods are labor intensive and involve a costly manual process in customizing the content for every unique device type and additional disk space, and/or program space, and/or services on the host server.

In addition, images that are transmitted across a communications medium are of varying types, standard or non-standard, may or may not have text and control information associated with them. The text and control information that move with the image(s) are dependent upon operating environmental factors. Devices and their operating and rendering capacity are also a limiting factor. For example, a Personal Digital Assistance (PDA) with a wireless modem may be limited to rendering 1-bit black and white images having a screen a size no larger than 240×320 pixels. In another example, a laptop may have no image rendering restrictions as long as an image rendering software is compatible with an image type.

FIG. 11 illustrates an existing method of requesting and transmitting network content across a communications medium. As shown, a requesting device initiates access to network content operated on an Internet/Intranet host system. The request is made through a communications/gateway server which downloads the accessed network content onto the requesting device. The requesting device includes a customized application to execute the downloaded network content to fit the specific type of requesting device. Typically, different types of devices require different customized applications. Network content providers or the Internet/Intranet host systems often have to provide many versions of customized applications to fit for different types of devices.

Further, in the existing method, different systems on the network work independently without a comprehensive data delivery and processing strategy while maintaining autonomy, not communicating intelligently with each other to distribute the processing of information at the source of the information across a network such as the Internet or an intranet to increase the effective resource pool to service user requests, and comprehensive compression schemes to further reduce bandwidth utilization from end to end.

It is with respect to these and other considerations that the present invention has been made.

### SUMMARY OF THE INVENTION

In accordance with this invention, the above and other problems were solved by providing a filter proxy system comprehensive content acceleration and automated content formatting and method for re-authoring, re-purposing, and/or compressing content control languages and/or images for delivery and/or interaction with devices of varying capacity and/or bandwidth availability without operator's intervention, and interaction with other systems having same filter proxy systems for reducing bandwidth utilization between each other and a requesting device and distributing the re-authoring, re-purposing, and compression processing of the control language, and/or images, and/or other content for delivery of and/or interaction with devices of varying capacity and/or bandwidth availability without operator's intervention.

The present invention addresses the issues of access to the WWW or other Internet/Intranet network site by devices of limited capability, different operating systems, transport protocols, limited or constrained bandwidth whether the devices or host systems are on a wired or wireless network. The present invention provides a real-time “on-the-fly” filter proxy system that analyzes content control languages, e.g. mark-up languages (ML) such as HTML and WML, and re-authors, re-purposes, and/or compresses the ML, images and other associated content for delivery and interaction with devices of varying capacity and bandwidth availability in a real-time operational environment. Accordingly, the filter proxy system provides real-time intermediary processes without operator's intervention. Furthermore, the present invention addresses the issue of intelligently distributing the re-authoring, re-purposing, and compression processes to comprehensively reduce the bandwidth and effectively utilize processing resources between systems having the filter proxy system.

One advantage of the present invention is that it is not labor intensive and does not involve a costly manual process in customizing the content requested and downloaded from the WWW or other Internet/Intranet network site for every unique device type. The present invention also reduces bandwidth requirements for content movement by applying multiple compression schemes so as to speed up access to the World Wide Web or other Internet/Intranet network site via communications networks, such as, but not limited to, wireless circuit switched cellular AMPS (Advanced Mobile Phone Service), GSM (Global System for Mobile Communications), and CDPD (Cellular Digital Packet Data).

In one embodiment of the present invention, a method of providing a plurality of device profiles, a plurality of user profiles, and a plurality of content control language templates that determine and control how an original content control language is processed in “real time”. “Real time” is defined as at the time a request for information is made. Accordingly, the original content control language and its associated digital content are processed to be compatible with a requesting device for rendering and retention of original functionality, whenever possible, at the time the request is made.

Additionally, the present invention provides a filter proxy system to serve a request to access any given resource on any network site, for example, a WWW page, and download the content of the page to a device of limited capacity in such a manner that the functionality of the page is maintained. The content of the WWW page or generally network content, may include control code (e.g. mark-up language (ML) control code), script code, text, and/or images, and other forms of content.

In one embodiment of the present invention where a plurality of filter proxy systems exist on a network, each filter proxy system can recognize the other and communicate intelligently to pass the processing parameters as applicable to reduce bandwidth utilization and offload processing overhead. Furthermore, the re-purposing, re-authoring, and/or compression of control language, text and images of WWW pages for a specific device may be distributed to various filter proxy systems running on hosts across the Internet where the WWW page and content may reside or is in closer proximity thereof on behalf of the requesting filter proxy system making the request on behalf of a specific device or in accordance with the user's specifications. This embodiment further incorporates utilization of distributed caching retrieval of data that has already been re-authored, re-purposed, and/or compressed by a content host filter proxy system on behalf of its own user or another filter proxy system to further reduce the resource and bandwidth utilization across a network.

In one embodiment, the filter proxy system in accordance with the present invention analyzes the content to determine the format and whether a template exists or should be generated for the device. If the template exists for a page format based upon a device profile, a user profile, and a content control language (e.g. ML) template, the page is filtered according to specified rules of the template and then sent to the user requested device or a receiving device. If the ML contains executable VBscript and/or JAVAscript required as interfacing with the content, a text filtered from the ML template, which represents the functionality is mapped to the executable code. The executable code remains resident on the filter proxy system for execution upon response to the text from the user sent to the requested device. The re-authored and filtered WWW page and its content are cached and retained according to caching rules that apply at that time. As an example, a request made by a cellular phone may not have the capacity to execute the Vbscript or JAVAscript to interact or display a specific text data, image type, or perform a specific function. The filter proxy system, within the user's application session, correlates and maps the Vbscript and JAVAscript code with an appropriate user's response to data entry or a hyperlink to a specific text sent to the cellular phone, such as a product description. Upon choosing to purchase a product on the cellular phone by highlighting an appropriate text and pressing an appropriate button, a user's response would be sent to the filter proxy system. The filter proxy system executes the appropriate code on behalf of the cellular user to provide a correct response for the host of a WWW page. This process is transparent to the host of the WWW page as well as the user of the cellular phone.

The present invention also provides a unique solution to bandwidth usage and control when transmitting ML, text, images, and other content over local and wide area networks, wired, or wireless communications media. In particular, but not restricted to, the wired or wireless Internet communications media benefit from the transmission of smaller compressed image files to a diverse number of devices with different rendering capacity. The smaller the ML, text, images, and other content sizes are, the less bandwidth utilized and made available resulting in less download time. Accordingly, providers of image rich content can disseminate the content to a larger and more diverse customer base. Additionally, the ML and text are compressed to further reduce bandwidth usage and decrease download times. Furthermore, bandwidth savings are accomplished by implementation of custom transport protocols to reduce acknowledgement transmission chatter between the device and server, reduce the number of TCP/IP connections required for the content referenced by the ML when executed on the device as is the case with the HTTP protocol, support a persistent connection, and transmit the data in a data streaming method.

Furthermore, the present invention provides a method of repurposing, re-authoring, and compressing network content. Re-purposing is generally defined as a process of re-formatting content including, but not limited to, text and images to meet system, device, and user specifications. Re-authoring is generally defined as a process of editing a control language, such as a mark-up language, for the effects in the control language after the re-formatting/re-purposing of the network content. Compressing is generally defined as a processing of reducing a file size based on a file type and format.

The present invention can re-purpose an image, i.e. change the image to meet the system, device, and user specifications “on the fly”, i.e. at the time the image is requested. Accordingly, the present invention overcomes the problems caused by the existing systems wherein image re-purposing is static and must be done for each device independently as well as each time the hosted image changes. Additionally, the present invention provides a faster download time for a user/requestor of content having images therein. Wireless infrastructure using the present invention can support a larger numbers of users that have the capacity to download images. This is particularly useful in wireless communications because of the limited number of frequencies with limited bandwidth available to serve a large and growing user base.

The present invention further provides a method of processing images “on-the-fly” such that an original digital image of any type, requested to be sent to a receiving device, is converted to a device independent bitmap (DIB), enhanced, pre-compression enhanced, compressed, or further compressed to reduce its file size and output the required file type and format. The original digital image may be re-sized and/or further altered to meet the specific physical requirements of a rendering device, the requirements of a requestor for the image whenever applicable, and the requirements of a network system so as to reduce bandwidth usage on a network.

Additionally, the present invention provides a filter proxy method capable of processing both static images and digital video, whether it is a streaming or static video content. For example, the filter proxy method further compresses a 24-bit RGB JPEG image requested for transmission to a laptop having a wireless modem and a full color display, a robust operating system, and an Internet browser so as to reduce the download time over a wireless communications medium. The method includes converting the same original JPEG image to an 8-bit color or gray scale JPEG image, and reducing the pixel size of the image to a size adapted for a particular Personal Digital Assistant (PDA) or to a 1-bit black and white image for a particular cellular phone at the time of the request “on the fly” before transmitting the image to a rendering device. The same process is applicable to converting and compressing frames of MPEG video for a player (rendering software) on a specific device.

In one embodiment, the method includes access to and use of the device specifications as required to process the ML and its content to include image, text, and other content for any particular device defined in a database. Such pertinent device information is termed as a device profile.

Further in one embodiment, the method includes access to and use of user definable filter processing parameters. In particular, the image and text processing specifications can determine how the method processes the image and text according to the requestor's specifications, limited to the rendering device of the requestor being capable of accommodating such specifications. Such pertinent user information is termed as a user profile.

Still in one embodiment, the method includes managing a user profile to restrict how the mark-up language, text, and images are to be re-authored and re-purposed by the filter proxy system to control bandwidth use by enforcing specific parameters in the user profile. Any such parameters referenced in the user profile that are in conflict with a devices capacity are superceded by the device profile parameters that define the limitations for a specific device. A user/requestor has permission to specify user profile parameters in a filter proxy system via a user interface to access the user profile. The user/requestor may change their user profile at any time “on-the-fly” via a control interface provided the user of which but not limited to, the preferred embodiment being the authoring of control language embedded in every requested web page that provides such a user control interface. This embodiment of user interface for real-time control of user preferences may also provide access to their e-mail and other services as are appropriate without having to log-on to another service or hosting site. The last or previous user profile updated by the user may be set as a default, which is referenced and loaded for parameters at the time of login.

Still in one embodiment, a user profile, which contains user preferences of how image content is to be delivered, as well as a required graphical user and programmatic interface to enable the user to update these preferences at any time, is provided on a requesting device or alternatively through another connected device. A user/requestor surfing on the WWW may merely look for text information and not care about image information. The user profile would then indicate image striping, which removes all images and image reference in the mark-up language before any content is downloaded to a user's device. This would drastically reduce download time, which may be the intent of the user making the request. Further control through the interface may allow the user to set image quality and compression ratios, size, and type. Accordingly, the user profile provides control information associated with images. A user is able to control the preference in rendering the requested information. Thus, devices and their operating and rendering capacity are not a limiting factor anymore to access to WWW information.

The present invention further provides a method of processing requests by a user on a digitally wired or wireless communications medium whether it is over the public/private Internet or a private local network, for content that contains images by way of a filter proxy. In one embodiment, the filter proxy system retrieves content on behalf of the requester, re-purposes image content and its control code per rendering device and/or requestor specifications, and then provides the requested content to the user. Each request for URI content is initiated and downloaded by and to the filter proxy system on behalf of the requester. The content is analyzed for image files that are re-purposed according to the device and/or user profile. The filter proxy system fetches the device and/or user profiles from a database that controls the processing of any images according to the most recent user profile but not violating the device profile constraints.

The present invention further provides a method of processing requests by a user on a digitally wired or wireless communications medium, whether it is over the public/private Internet or a private local network, for URI content by way of a filter proxy intelligently communicating with another filter proxy having same capacity and managing the performing of the processing on behalf of the requesting filter proxy making such a request on behalf of a user so as to reduce bandwidth utilization between the two filter proxy systems. In one embodiment, the filter proxy system intelligently communicates with another filter proxy system on a network to which the processing parameters for the particular request are passed to and where the re-purposing, re-authoring, and compression of control code, text, and image content as per the rendering device and/or requestor specifications will be performed on behalf of the requesting filter proxy system to reduce the bandwidth utilization between them and offload the required processing for making the content device compatible. Distribution of the processing between the two communicating filter proxy systems is managed in such manner as to maintain quality of service (QoS) on both filter proxy systems, which includes balancing the processing, reducing bandwidth utilization, meeting the device and user content requirements, and download times.

Further in one embodiment, the filter proxy system operates in such a manner as to handle many such requests from same and/or different types of rendering devices simultaneously so as to reduce the bandwidth required to send the image content over the wired or wireless communications medium and reduce the download time to the requesters. In one embodiment, the filter proxy system is integrated into a network according to its required operating environment, service level, and type of network, etc. In another embodiment, the filter proxy system may exist on a client/gateway with several separate components. In one embodiment, the components include a client proxy resident on a user's device, a communication/gateway server, a filter proxy having a master browser and filter proxy server array, an image and ML caching server farm, and a caching retrieval server. A server may be a software component resident with other server software components on a single physical server or individual physical servers. Accordingly, a user no longer connects directly to the requested URI host. Instead, a connection is made between a user and the filter proxy via a communications/gateway server where a session is established and a desired URI and all referenced URI contained therein are downloaded on behalf of the user so as to be able to re-purpose, re-author, and compress the ML, text, images and other content for the specific device and user. The filter proxy can further determine if another implementation of the filter proxy system resides on the requested URI host or network and pass the processing parameters to it where re-purposing, re-authoring, and compressing the URI content, such as ML, text, images and other content for the specific device and user, can be performed on its behalf. The filter proxy uses a proxy cache in its back end operations for a URI's original content and a changed/filtered content (versioning) to include the image and mark-up language, ML templates, and suspended user sessions as required by the operational environment. Accordingly, no changes are required on a WWW server that hosts the requested original URI content, although it may have the same filter proxy system operating wherein further bandwidth savings can be accomplished and efficient distribution of processing of the required compression, re-purposing, and re-authoring may be accomplished on behalf of the requesting filter proxy system. Support components may include databases for the device and user profiles, ML templates, accounting, logging, etc. The support components may also include operations for memory caching of URI and its original and changed content having a high request count. These caching support components reduce the overhead of re-authoring and re-purposing the same ML and images. The filter proxy system further includes the functional components, which re-purposes text and image content, re-authors a mark-up language as required for a specific device, and compresses the mark-up language, text, images, and other content.

Further in one embodiment, the filter proxy resides in a server environment. The filter proxy may also process in a multiple processor server environment using shared memory or an inter-process communications protocol. Accordingly, requested content does not have to be stored on a permanent storage medium before being processed, such as a hard disk, thus increasing throughput and number of simultaneous requests processed.

Additionally in one embodiment, the filter proxy includes image-processing and compression filters, ML re-authoring and editing filters, ML and text compression filters, and as appropriate a custom transport protocol component. These filters and components are componentized so as to enable and facilitate resource utilization, load balancing, and bandwidth throttling when many simultaneous requests are made that use both processing services as well as the available bandwidth. For example, bandwidth throttling may be accomplished by measuring the resources available versus the requests pending and may force the specific re-purposing and levels of compression of images without enhancement of the images to make more processing resources available. Additionally, the amount of compression applied on an image may be increased during a high use period, thereby reducing the bandwidth required for image content to be downloaded. Statistics of logging of resource usage can be used to provide information for growth of the system if desired.

For a better understanding of the invention, reference should be made to the drawings, which form a further part hereof, and to accompanying descriptive matter in which there are illustrated and described specific examples in accordance with the invention.

### BRIEF DESCRIPTION OF THE DRAWINGS

Referring now to the drawings in which like reference numbers represent corresponding parts throughout:

FIG. 1 is a schematic view of a network for Web to wireless mobile Internet communication system having a filter proxy system in accordance with the principles of the present invention.

FIG. 2 is a schematic view of functional relationships and operations of the filter proxy system in accordance with the principles of the present invention.

FIG. 3 is a schematic view of filter proxy processes and a load balancing technique of the filter proxy system in accordance with the principles of the present invention.

FIG. 4 is a schematic view of a client proxy configuration of the filter proxy system in accordance with the principles of the present invention.

FIG. 5 is a schematic view of an exemplary device profile database of the filter proxy system in accordance with the principles of the present invention.

FIG. 6 is a schematic view of an exemplary HTML template and user profile database of the filter proxy system in accordance with the principles of the present invention.

FIG. 7 is a schematic view of exemplary process parameter relationships of a filter proxy operation of FIG. 10. FIG. 8 is flow chart of filter proxy operations in accordance with the principles of the present invention.

FIG. 9 is a flow chart of filter proxy operations of ML re-authoring, image re-purposing, and text/image compression in accordance with the principles of the present invention.

FIG. 10 is a schematic view of an exemplary filter proxy operation of filtering for a PDA device with image capacity in accordance with the principles of the present invention.

FIG. 11 illustrates an existing method of requesting and transmitting network content.

FIG. 12A illustrates a first embodiment of a filter proxy method for requesting and transmitting network content in accordance with the present invention.

FIG. 12B illustrates a second embodiment of a filter proxy method for requesting and transmitting network content in accordance with the present invention.

FIG. 12C illustrates a third embodiment of a filter proxy method for requesting and transmitting network content in accordance with the present invention.

FIG. 12D illustrates a fourth embodiment of a filter proxy method for requesting and transmitting network content in accordance with the present invention.

### DETAILED DESCRIPTION OF THE PREFERRED EMBODIMENTS

The present invention relates to a filter proxy system for comprehensive content acceleration and automated content formatting and method for re-authoring, re-purposing, and/or compressing content control languages and/or images for delivery and/or interaction with devices of varying capacity and/or bandwidth availability without operator's intervention, and interaction with other systems having same filter proxy systems for reducing bandwidth utilization between each other and distributing the re-authoring, re-purposing, and compression processing of the content control language and/or images for content for delivery of and/or interaction with devices of varying capacity and/or bandwidth availability without operator's intervention.

A generalized and exemplary list of components, functions, and filters that are incorporated into one embodiment of a filter proxy system for handling requests, re-purposing of images, compression, and/or re-authoring the content and mark-up language, are as follows:

Client Components and Proxy

A user proxy module operable on a requesting device, or equivalent means to redirect URI requested to the filter proxy system.

A client proxy module that provides custom transport protocol capability having the ability to accept data streamed from the filter proxy system, support a continuous connection with the filter proxy system, and reduction of the number of TCP/IP connections made for referenced content in the ML, reduce the number of acknowledgements for received packets, and custom packet sizes.

A user proxy module operable on the requesting device, when applicable, which provides secure communications and content control.

A browser and image-rendering module.

ML, text, and script compression and decompression module.

Custom rendering applications that can maintain secure control of the content to the user.

User Profile Application Support (as Applicable)

User defined configurations and interface thereto.

User control interface to set user preferences for content re-purposing and compression.

A “speedometer” visualizing the apparent download speed.

A transparent user setting (raw or un-enhanced access to the Internet).

Support for other proxies on client or no proxy setting.

URL access limitations as set by user or corporations.

User authentication and data encryption.

Communications/Gateway

Establishing a connection via a communications/gateway server upon a user request.

User interface for user profile update.

Caching a transport protocol, such as HTTP.

User authentication, e.g. two (2) factor authentication.

Logging and alarm functions.

Byte usage and other accounting features.

Compliant with standard transport protocols, such as HTTP 1.0 and HTTP 1.1 as well as allowing for custom protocols.

Online Help as necessary.

Master Browser and Filter Proxy

Access to device and user profiles and ML template databases as well as logic to process and filter according to profile specifications.

Access and logic to search and retrieve a target URI from a cache and a host system over a network, process according to the device and user profiles, and analyze, coordinate, prioritize, and task filter functions for one or multiple simultaneous URI requests.

Logic to download all URI mark-up language and content, such as images on behalf of the client proxy, process them concurrently, and send them to the requesting via the client proxy on the requesting device as a single data stream to reduce the number of TCP/IP connections made by the device for every content referenced in the ML, bandwidth utilization, and filter proxy resources.

Logic to recognize, communicate, pass processing parameters, and manage with another same filter proxy system the processing resource distribution, process balancing over a network, compression of the processed data to reduce bandwidth utilization between the two servers, and a data streaming protocol.

Load balancing data and processes across multiple servers of the filter proxy.

Distributed Internet/intranet caching and retrieval logic between a requesting server having a filter proxy system and a content & ML host having the filter proxy system to reduce the process overhead of ML and content previously re-authored, re-purposed, and/or compressed.

ML page analysis and profiling based upon device and user profiles for determination and/or generation of best-fit ML template for ML page.

Re-authoring ML as required based upon profiles and template parameters.

Image filters for re-purposing and compression logic and operations for:

an image enhancement and/or compression process.

24-bit RGB color to 16- and 8-bit color conversion and compression.

24- and 8-bit color to gray scale both 8- and 1-bit black and white conversion and compression. Format conversion from BMP, TIF, PNG, and GIF to

JPG, TIF, PNG or other format.

Conversion of animated GIF to static GIF, PNG, or JPEG formats.

Video image streaming format conversion and compression.

Removal of all images or selective removal of images, e.g. removal of GIF.

Automatic resizing of images based upon the device and user profiles.

Converting to special image formats.

ML re-authoring and editing filters and logic as required by profiles and template parameters:

White space elimination.

Header conversion or elimination.

Background images elimination.

Comments elimination.

Meta tags stripping.

Tables re-authoring and presentation.

Frames re-authoring and representation.

Text re-formatting.

Font conversion.

Dynamic page presentation.

Java Applets execution or elimination.

JavaScript and VBScript proxy execution or elimination.

Plug-ins such as audio and video files elimination.

ML referenced document conversion. (Such as PDF file converted to HTML Text).

Re-authoring ML as a result of image re-purposing

Removal from original ML any code fixing the size of images

Error trapping and recovery logic to handle conditions not addressed in the re-authoring and re-purposing logic.

Authoring each page of ML by adding control language that provides a real-time user control interface on each Web page for user preferences of content re-purposing and compression parameters, such as image size and compression ratios.

ML, text, and script compression and decompression filters and operations.

Logic to execute client side script so as to be able to accelerate content delivery.

Logic to map and execute control code and script on behalf of the user and device on the filter proxy system when the device has limited capability.

Databases

Protocol (HTTP 1.0/1.1) database accessed by the communications/gateway server.

Device and user profiles database and error logging.

Mark-up language (ML) template database.

Security database.

User account database.

Statistical

In the following description of the preferred embodiments, reference is made to the accompanying drawings, which form a part hereof, and in which is shown by way of illustration several embodiments in which the invention may be practiced. It is to be understood that other embodiments may be utilized as structural changes and may be made without departing from the spirit and scope of the present invention.

One embodiment of the present invention includes: 1) URI directing module and custom transport protocol that reduces the number of connections made to retrieve the URI mark-up language and it referenced content, supports a continuous connection, and accepts data streamed from the filter proxy system on a requesting device (Client Proxy); 2) a communication/gateway server that establishes a session with a remote device and creates a communication path with the filter proxy; 3) a set of content filters (Filter Proxy) that: (a) intelligently accepts redirected requests, retrieves and caches the requests on behalf of the requesting device; (b) includes a URI and ML content analysis component; (c) has a set of callable filters or a library of filters that perform the filtering and processing of the text, images, embedded script code, links, functional mapping, compression, and ML re-authoring and editing and conversion as a result of the analysis of the original mark-up language, its content, device and user profiles, and ML template; (d) has a software component that establishes whether the URI is in cache, up-to-date, and/or already pre-processed for a given device; 4) a Web page/URI caching server farm; 5) primary databases composed of the device and user profiles, error logging and statistical information, and secondarily those for security and user accounts; and 6) a Web page/URI caching retrieval server that: (a) communicates with host where requested URI resides; (b) communicates with another implementation of the filter proxy system present at the requested URI host; (c) passes the parameters for re-purposing and re-authoring the ML, text, images, and/or other content to the URI host filter proxy system to distribute the processing, reduce the resource utilization on requesting filter proxy system, and reduce the bandwidth utilization between the two filter proxy systems; (d) request of URI may be serviced from cache of the host filter proxy system if URI has previously been filtered by the hosting filter proxy system. These components may reside on a single physical server having a single or multiple processors or on multiple physical servers having one or more physical processors each and may be distributed across a network or networks. All processes work in a real-time environment to process the content “on-the-fly” at the time a request is made for final delivery to a requester.

In one embodiment, the method is further defined by the filter proxy system having the means and mechanisms for: 1) establishing, entering, updating, and retrieving device and user profiles specification and templates in the respective databases; 2) analyzing the ML while applying the specifications of the device and user profiles to determine what data formatting filters, e.g. re-purposing, re-authoring, and/or compression filters are required; 3) analyzing of the ML while applying the specifications of the device and user profiles to define an ML template or establish the best fit of an existing ML template to further refine the process of re-purposing, re-authoring, and formatting the ML and its content for a specific device and user; 4) calling and executing the proper filters that perform the filtering and processing of the ML and its content; 5) prioritizing and tasking the filtering and processing to different servers of the filter proxy server array for purposes of improving through-put and load balancing; 6) bandwidth-throttling by controlling how much ML re-authoring and/or when image enhancement and/or image pre-compression filtering are performed prior to compression; 7) may eliminate all duplicate references to a hyperlink/URI by text and/or graphics and utilizing control information from (1), (2), (3), and (4) above; 8) mapping to the filter proxy server memory relationships between hyperlinks and script to text and hot buttons sent to the user based upon the device capacity defined in the device profile; 9) executing on behalf of the device the hyperlinks and script code mapped on the server of the filter proxy upon a response of the user when necessary; 10) converting the executable ML to the proper language as defined by the device profile; 11) allowing the user to change their preferences and/or user profile at any time to define how the filter proxy re-purposes and compresses image content and text to be downloaded to the user so long as it conforms with the capacity of the device as defined in the device profile; 12) enhancing, converting, and/or compressing images to fit the device and user specifications and decrease the bandwidth requirements and download time; 13) converting various document forms to the device ML such as HTML; 14) compressing the text, ML, and script to decrease the bandwidth requirements and download time; and 15) providing a transport protocol that may be a standard, such as HTTP or a custom protocol that supports a continuous connection, reduces the TCP/IP connections required for the ML and its referenced content, improves the ratio of packet to response retaining data integrity and recovery, and supports data streaming between the server and the requesting devices having the appropriate client proxy.

It will be appreciated by those skilled in the art that the process and methods described herein may operate on the Internet, Intranet, or a local network over a wired or wireless connection.

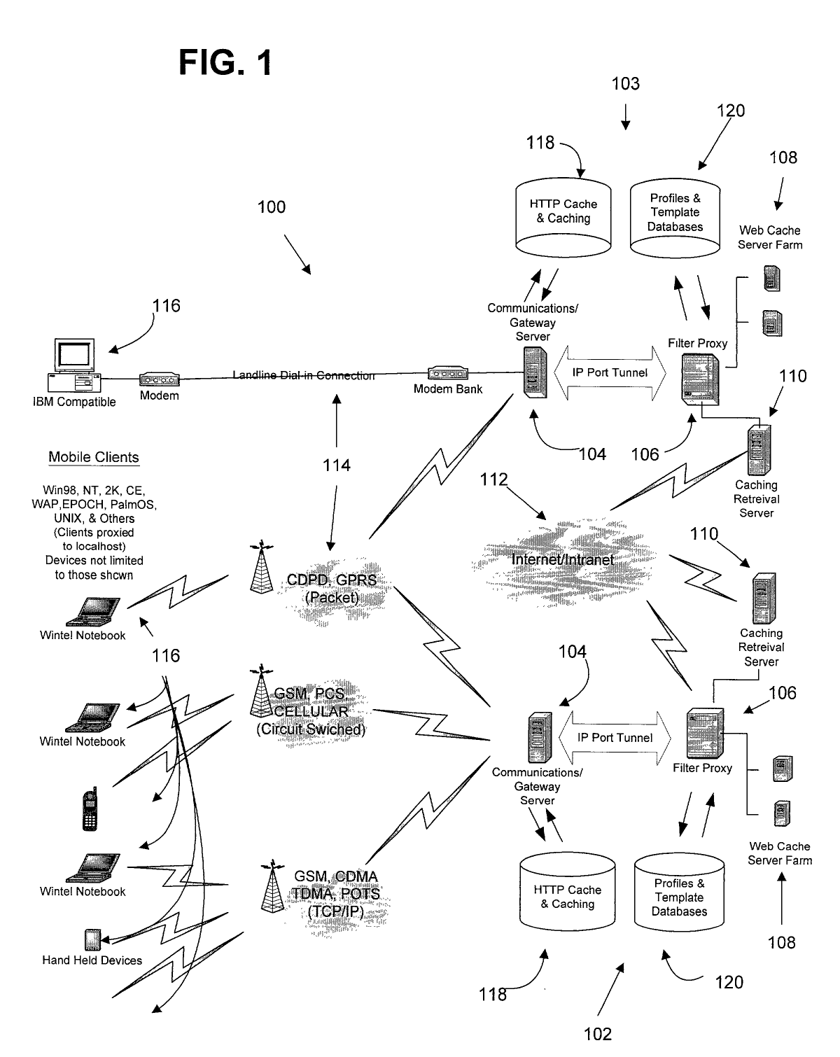

FIG. 1 depicts one embodiment of a network for Web to wireless mobile or wired dial-in Internet communication system 100 having a filter proxy system 102 in accordance with the principles of the present invention. The filter proxy system 102 provides a method for re-authoring mark-up language (ML) and/or control languages, such as HTML and WML, re-purposing the associated content, such as text, document files, and images. The re-authoring or filtering of the ML may, but not limited to, address updating the ML when referenced content is re-purposed, editing out comments and white spaces, formatting the content in accordance with the user's preferences and profile and the device capabilities in accordance with the device profile and/or translate the ML language and/or control languages into an appropriate ML or control language used by a device further defined by its device profile. The device profile provides device specific parameters required for re-authoring the ML for rendering on a device that can further be refined and controlled by the application of templates.

The filter proxy system 102 includes a communications/gateway server 104, a filter proxy 106, a Web cache server farm 108, a caching retrieval server 110, and databases 120. The communications/gateway server 104 establishes a connection with a user/requestor's device 116 to the Internet 112 via a variety of communication media 114. The filter proxy 106 is coupled to the communications/gateway server 104 through an Internet Protocol (IP) port tunnel. The filter proxy 106 also communicates and controls the Web cache server farm 108 and the caching retrieval server 110. The communications/gateway server 104 may use a cache 118 for its transport protocol. The filter proxy communicates and fetches processing parameters such as user and device profiles and ML template from databases 120.

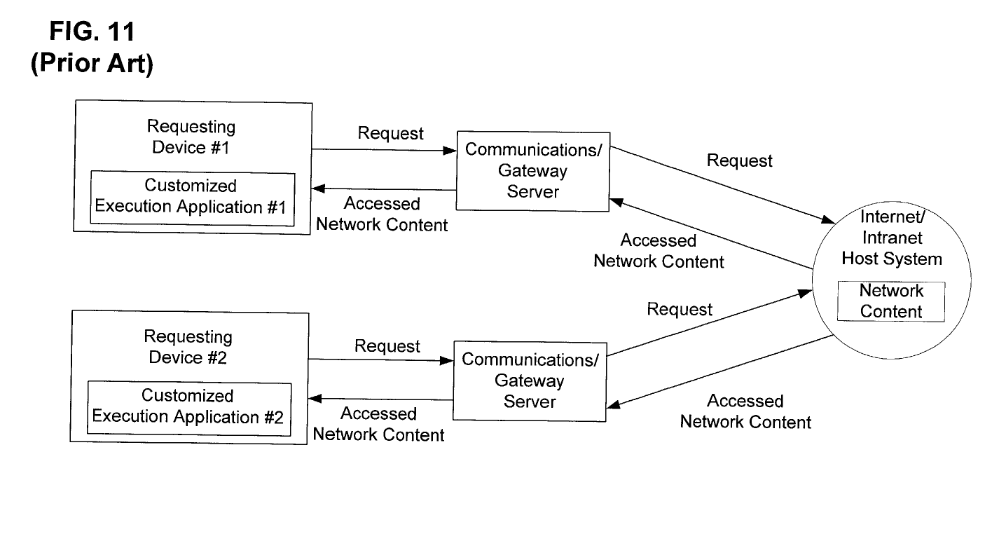

In FIG. 1, a user no longer connects directly to a requested URI or network content host or provider on the Internet via a communications/gateway server as illustrated in FIG. 11. Instead, in FIG. 1, a connection is made between the user and the filter proxy 106 via the communications/gateway server 104. The filter proxy system 102 uses the cache & caching memories 118 for a URI's original content and a filtered content to include images and mark-up language, as well as databases for device and user profiles stored in the databases 120, ML templates, accounting, and security as required by the operational environment. Accordingly, no changes are required on a WWW server that hosts the requested original URI content on the Internet. The databases 120 that are stored on memories may include device and/or user profiles, ML templates, accounting, logging and statistics. The cache & caching memories 118 may include caching of URI and its original and changed content having a high request count. The databases 120 and the cache & caching memories 118 facilitate and reduce the overhead of re-authoring and re-purposing the same ML and images. The filter proxy 106 then applies the proper filters to re-purpose text and image content, re-author mark-up language as required for a specific device, and/or compresses the mark-up language, text, and image.

Furthermore in FIG. 1, the requesting filter proxy 106 may intelligently communicate with another filter proxy system 103 that hosts the requested URI, pass device and user parameters for re-purposing and/or compression processing of the ML and content on behalf of the requesting filter proxy 106 where the processing of the filter proxy system 103 occurs for purposes of reducing bandwidth and distributing processing and/or may be retrieved from cache if the URI has been previously filtered. Such content already processed and resident on the host filter proxy system 103 may be accessed directly from its Web cache server farm 108 without further processing. The filter proxy system 103 preferably includes the same components as the filter proxy system 102.

The changing/re-authoring of the ML or control language by the filter proxy 106 can be done at the time a requested URI is downloaded or made available from the cache 118 to the filter proxy 106 such that an original ML may remain dynamic at its host. For example, as depicted in FIG. 10, the filter proxy 106 retrieves and converts a 24-bit color RGB image referenced in an original ML hosted on a remote server on the Internet to an 8-bit grey scale image and alters its size to meet device specifications. The associated text of the original ML retrieved is also formatted to meet the device specifications. All required hyperlinks are mapped in the cache 118 of the filter proxy ready for execution on behalf of the device upon a corresponding user response. The owner of the original ML may change the image and the associated text at any time residing on a remote server(s) without the ML or content having to be customized manually for a specific device. In one embodiment, the rules that establish how the image, text, and functionality are to be changed are dependent upon and defined primarily by the device profile, further by the user profile, and the ML template. The analysis of an ML page for a specific device profile establishes the characteristics required to associate a best ML Template that will provide the re-authoring parameters, such that the re-authored ML and its content are formatted for the specific requesting device. Accordingly, the filter proxy 106 reduces the overhead required to process the ML and its content. The last or previous user profile updated by the user may be set as the default, which are referenced and loaded for parameters at the time of login. Furthermore, the filter proxy 106 controls URI content processing parameters and available system resources for such processing based upon bandwidth availability, number of concurrent users, and filtering load. During periods when bandwidth availability restrictions exist, the filter proxy 106 is capable of reducing the bandwidth available per user session thereby reducing the need for queuing and thus servicing more sessions effectively. When large numbers of concurrent users are making requests, the filter proxy 106 may over-ride user parameters and restrict the image enhancement and pre-compression processes that consume processing resources to balance the available resources and service all users equitably during peak periods.

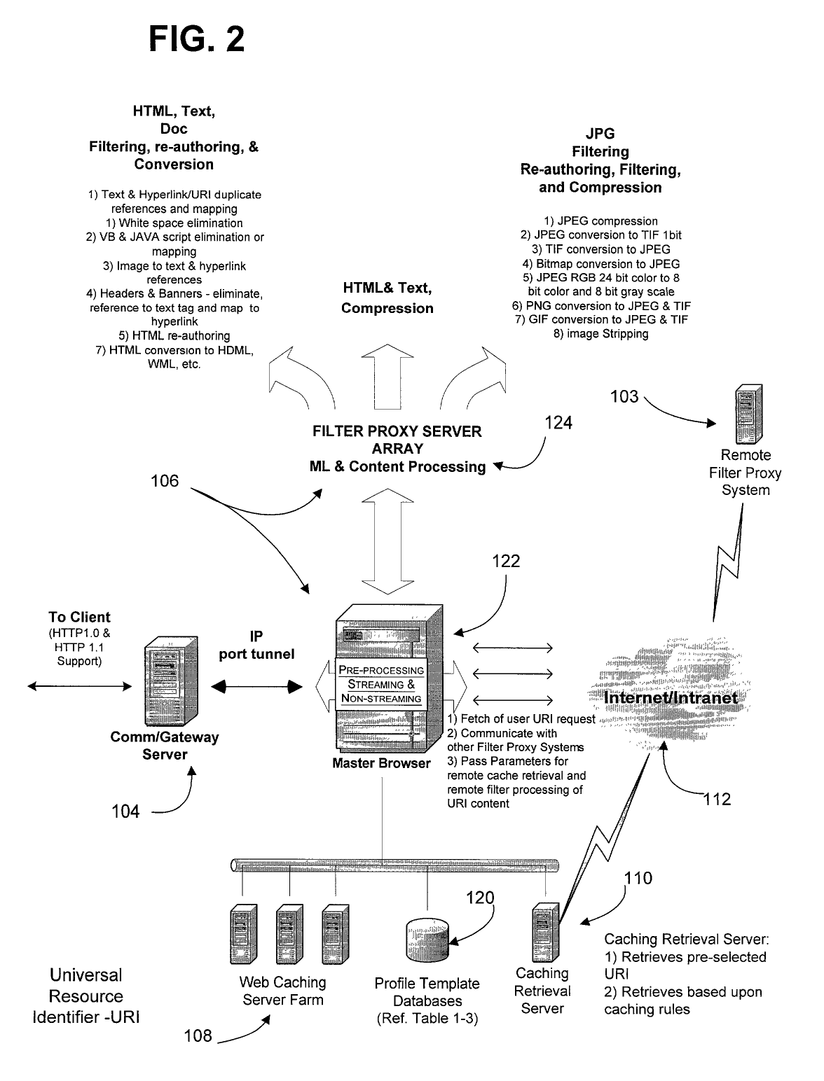

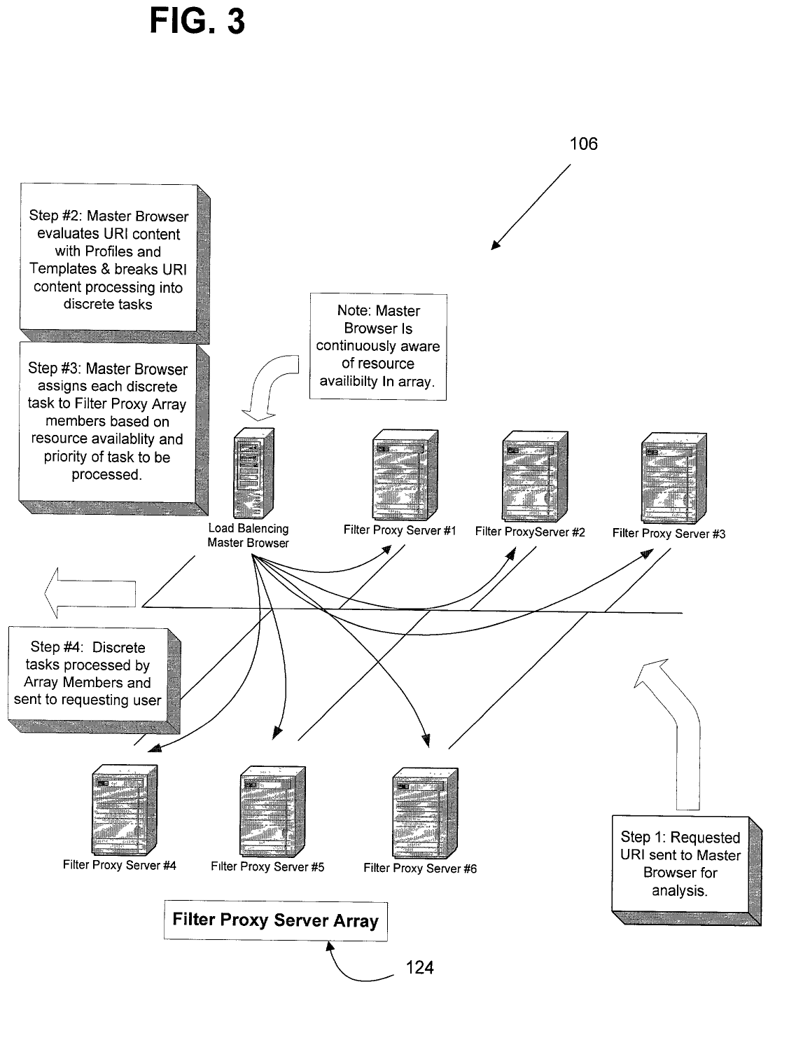

FIG. 2 is a schematic view of functional relationships and operations of the filter proxy 106 in the filter proxy system 102, 103 in accordance with the principles of the present invention. The filter proxy 106 includes a master browser 122 and a filter proxy server array 124 for processing ML and content. The master browser 122 preferably is the primary control service that provides the functionality required to direct, control, and monitor the filtering and caching processes as per the exemplary filter functions previously defined under the title of Master Browser & Filter Proxy (see also FIG. 3). The filter proxy server array 124 is capable of processing a plurality of MLs and contents virtually the same time.

In operation, a user, via a client proxy on a device or some other means, directs a client browser to the communications/gateway server 104 associated with the filter proxy 106 and requests a connection. Then, the communications/gateway server 104 establishes a connection between a device and a communications network. The network can be wired or wireless. Depending upon the type of service(s) provided, the connection may be in either a secured or unsecured nature. The communications/gateway server 104, upon establishing the connection, passes the connection information to the filter proxy 106 where an application session is established. The profiles associated with the user and the device are then retrieved from the databases 120 for processing any request for a URI upon its receipt from the connected device. Upon receipt of the request for a URI, the filter proxy 106 performs the required tasks to establish the validity of the request, i.e. whether the URI is cached or current, and/or whether the cached URI is already formatted for the requesting device or not. The user or host services, via the user profile, may restrict access to a valid list of trusted URI's or allow global access to any URI available on the network. Upon establishing access rights to the requested URI, the filter proxy 106 checks its cache 118 to determine if the URI is already resident to determine whether it requires to be downloaded in its entirety or only the most current associated content, and initiates a connection with the host of the URI to determine whether any changes to the original URI format or content have occurred since last downloaded. If the cached URI and all content are current, the connection with the URI host is terminated, and the filter proxy 106 uses the cached URI content.

If the URI is not in cache 118, the master browser 122 establishes whether a same filter proxy system 103 is resident at the URI host. If the filter proxy system 103 is present at the URI's host, parameters for re-authoring, re-purposing, and/or compressing the requested ML and its content are sent to the URI's host where the URI will be processed on behalf of the user so as to reduce the bandwidth used between the two hosts and optimize the processing resource utilization across the network. Such processing by the URI's host filter proxy system 103 on behalf of the requesting filter proxy system 102 may be determined by the existing load and the need for original content by the requesting filter proxy 102. Regardless, in one embodiment, compression of the original ML and text will occur as well as for the associated images whereupon downloading of the data continues.

If the requested URI content is cached and it is determined that the content has been changed since last cached, the caching retrieval server 110 establishes connection with the URI host filter proxy system 103. The parameters for re-authoring, re-purposing, and/or compressing the content are sent to the URI's host where the URI will be processed on behalf of the user so as to reduce bandwidth used between the two hosts and processing resource utilization based. The existing load and the need for original content by the requesting filter proxy 106 may determine such processing by the URI's host filter proxy system 103 on behalf of the requesting filter proxy system 102. Regardless, in one embodiment, compression of the original ML and text will occur as well as for the associated images whereupon downloading of the data continues.

URI in cache is determined by comparison of the cached version with that being downloaded, initially a header and metadata, and finally the content such as ML, text, and image tags, etc. Additionally, cache is checked for a current device version of the URI content as a result of a previous request. One of the purposes of identifying a content type of a URI within a ML template is to reduce the overhead for determining the immediate need for content update.

As shown in FIG. 3, the filter proxy 106 analyzes the ML and URI content. The filter proxy 106 uses the device and user profile parameters for re-purposing of any text and images, maps ML functionality for execution on the server of the filter proxy 106 on behalf of the requestor, and/or re-authors and converts the ML according to the device and user profiles parameters using the best fit ML Template.

In FIG. 3, the master browser 122 performs the analysis of the ML and its content retrieved from the URI utilizing the system, device, and user profile databases 120 and the ML templates to determine what processing must occur. The ML and content processing is broken into discrete tasks by the master browser 122 that assigns them to filter proxy server array 124 on one or more processors and/or server devices for processing to meet the device and user dependent requirements. Finally, upon completion of processing all elements, the new ML and content are sent to the requesting user.

Furthermore, the master browser 122 measures resources available and prioritizes tasks and filtering to be performed by the filter proxy server array 124. These measurements are used to load balance processing and maximize user request processing on individual filter proxy servers on the array 124. The filter proxy 106 usually resides in a server environment. The filter proxy 106 may process in a multiple processor server environment using shared memory or an inter-process communications protocol such that the requested content does not have to be stored on a permanent storage medium, such as hard disk except for caching, thus increasing the throughput and number of simultaneous requests that may be processed.

Table 1 below lists exemplary filters having functional operations performed by the filter proxy 106.

TABLE 1

| | |
|---|---|
| 1 | Text & Hyperlink mapping |
| 2 | Text duplicates deletion |
| 3 | Text to hyperlink duplicate deletion |
| 4 | ML code white space elimination |
| 5 | Headers and Banners elimination text reference and hyperlink |
| | mapping |
| 6 | ML comment elimination |
| 7 | VB & JAVA script mapping for execution on behalf of the |
| | device and re-authoring of ML or elimination |
| 8 | JAVA applets reference removal or mapping for execution on |
| | behalf the device |
| 9 | Plug-in reference elimination or translation of content to a |
| | device compatible plug-in format and re-author |
| 10 | ML authoring for device dependency specifications |
| 11 | ML re-authoring to user specifications |
| 12 | ML re-authoring to ML Template |
| 13 | Convert Tables to Text and map functionality and hyperlinks |
| 14 | Convert Frames to text and map functionality |
| 15 | Convert original ML to device dependent ML or control |
| | Language |
| 16 | Compress ML and script language to device dependent |
| | specifications |
| 17 | Compress text |
| 18 | Image striping and deletion |
| 19 | Image reference ML re-authoring |
| 20 | Image conversion to device dependent format |
| 21 | Image re-sizing to device dependencies |
| 22 | Image re-sizing to user specifications |
| 23 | Image compression to device, user, and default specifications |
| 24 | Conversion of ML and content to a single image instead of |
| | executable ML and independent content pieces |
| 25 | Header and Banner elimination |
| 26 | Authoring user control into ML page for image purposing and |
| | Compression. |
| 27 | Meta Tag elimination |

It is appreciated that other functional operations can be performed within the scope of the present invention. It is also appreciated that the implementation of these functional operations is generally known in the art and not the focus of the present invention.

If the URI content is present in cache and is already formatted as per the device and user specifications, the filter proxy 106 transmits the re-formatted URI and the most current content to the device for rendering. The filter proxy 106 may compress the processed ML, text, and any associated script to further reduce the bandwidth requirements according to device capacity defined within the device profile. The filter proxy 106 may also perform required cache updating, logging of statistical data, and accounting information as required by the system. The communications/gateway server 104 transmits the re-formatted information to the device 116 using the available transport protocol over the wired or wireless network or media 114.

The following are the detailed descriptions of different modules of one embodiment of the filter proxy system 102 and filter proxy processes.

A. Client Services by Client Proxy Configuration

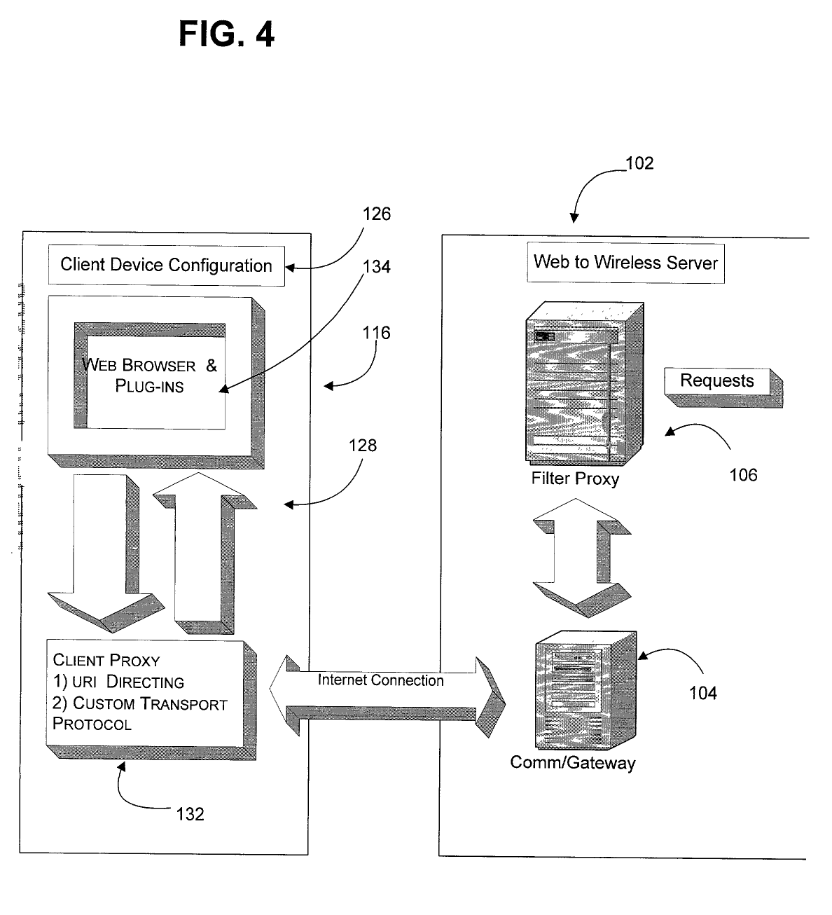

FIG. 4 illustrates one embodiment of a client proxy configuration 126 of the filter proxy system 102 in accordance with the principles of the present invention. The client proxy configuration 126 may be included on device 116 which is capable of communicating with the communications/gateway server 104 via some communication medium 114 having a web browser and operating system 128 or other software and hardware components, such as a component manager and security plug-ins, etc. The communication medium 114 enables the device 116 to execute a mark-up language, such as HTML, to render the content, and to interact with the user. A web browser 134 of the device interprets ML, renders content, executes script language, and allows the user to interact with the content and web provider or host services.

In FIG. 4, the client proxy configuration 126 may also include a client proxy 132 or equivalent means for directing the connection to the filter proxy 106 via the communications/gateway server 104, utilizing custom transport protocols other than HTTP that would further increase the efficiency of moving information across the communications medium by increasing the packet size and ratio to acknowledgments, and data stream the ML and its content at one time as an associated set of packets, not as individual requests as done by HTTP, thus eliminating a new TCP/IP connection for each referenced content, such as images. Furthermore, the client proxy configuration 126 may include plug-ins for special purpose applications, such as encryption, special file generation, and rendering applications all of which execute on the device and that may be under the control of the web browser or control the web browser and its functionality. It is appreciated that other client services can be implemented within the scope of the present invention. Examples of the other services which can be provided by the client proxy configuration 126 via the client proxy 132 or the web browser and operating system 128 are means of changing of the user profile, controlling applications distributed and updated over the network to the user's device, metering and billing of the distributed applications on the device based upon usage, a speedometer that shows the real-time compression and apparent increase in speed, account query capability, securing and retaining control of data on the device and during transmission, text data compression and decompression, and access to secure e-mail services, etc. Availability of each of these features may be device and host services dependent.

In a preferred embodiment, a user is required to interact with the filter proxy 106 to control content delivery and e-mail. This is accomplished by way of providing the user an interactive control box that has been authored by the filter proxy 106 and embedded on every page requested or provided to the user by the filter proxy 106. The control interface/box may be made up of icons wherein each icon represents a request for a service or a content processing parameter that the user wishes the filter proxy 106 to use or respond to. For example, the user desiring to increase the compression of images would click/choose an icon within a control interface depicting an action that would signal the filter proxy 106 that the user requested a change in the compression ratio of the images to further reduce the download time. The filter proxy 106 correlates the request with a process parameter, compresses the images of the current page, and resends the compressed images to the user as well as all subsequent images that would be processed for that particular user or until the user requests another parameter change. The filter proxy 106 may override a user parameter when system load balancing and resources require such.

B. Communications/Gateway Server

The communications/gateway server 104 provides standard services, such as the transport level protocol, HTTP, WTP, and HDTP, for caching of the protocol, establishing the session with the device, passing connection and URI request information to the filter proxy 106, and interfacing with the security components of the filter proxy system 102, such as device dependent encryption and user authentication. Information required to establish the application session on the filter proxy 106 includes, but not limited to, the user identification, password, device and browser type, and IP address. The communications/gateway server 104 may also count the bytes sent to and received from the user for purpose of statistical analysis or billing if desired. Another function that the communications/gateway server 104 provides is measuring bandwidth availability. The bandwidth availability information is sent to the filter proxy 106 to change the image enhancement processing and to increase the image compression so as to further throttle the data to increase available bandwidth, service more users, and meet user requirements during peak usage periods.

C. Profile Databases

The profile databases 120 may include device and user profiles. It is appreciated that other profiles can be used within the scope of the present invention. For example, the profile databases 120 may include security data for maintaining password, user access level information, and potentially user accounting information.

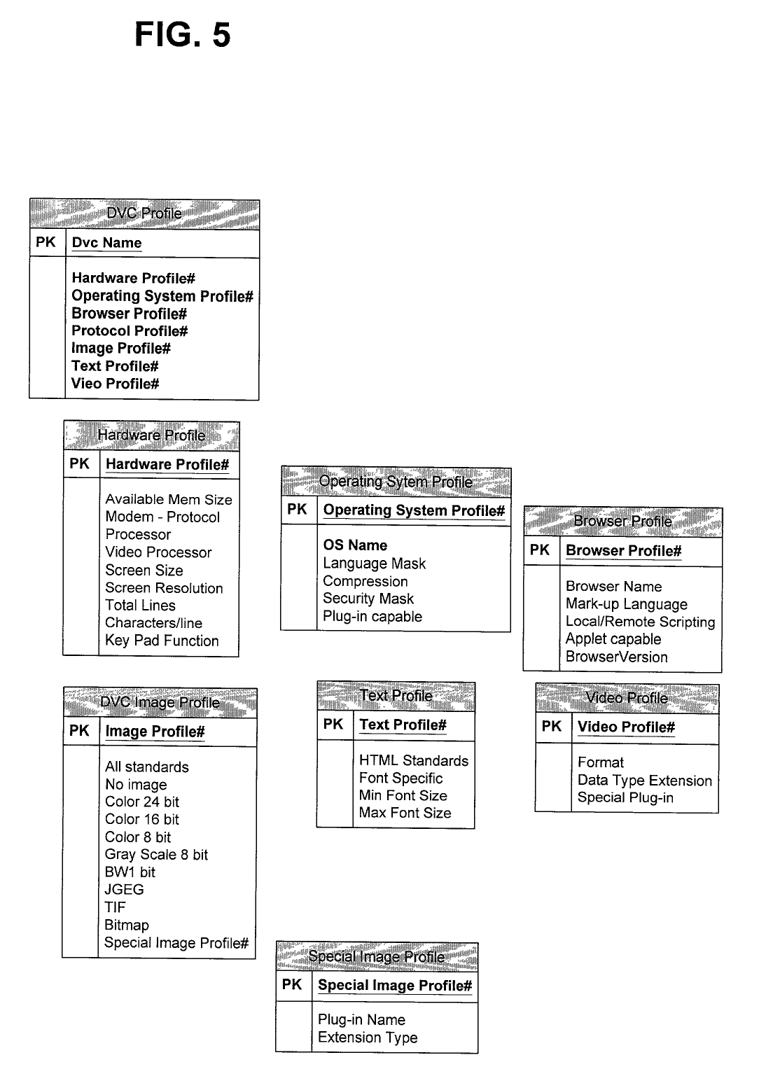

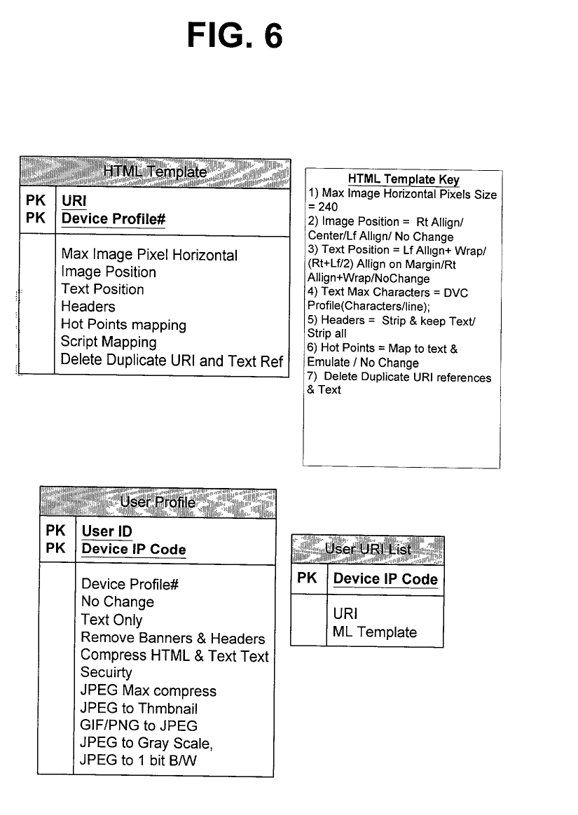

FIGS. 5 and 6 illustrate exemplary profile databases for ML templates, system, device, and user profiles of the filter proxy system 102 in accordance with the principles of the present invention. Controls and interfaces are provided to the profile databases such that the host and/or the user can have access to the appropriate databases based upon the operational environment. As an example, the device profile is only available to the hosting service through the filter proxy 106 and administrative service graphical user interface. It is appreciated that any administrative service graphical user interface can be implemented without departing from the present invention. The user profile may or may not be accessible to the user directly. When accessible, the user may do so via the interface provided on the requesting device or another device registered with the host services.

In general, a device profile defines to the filter proxy 106 the capabilities and limits of a device to render content, methods of interaction with a user, programmability, protocols, languages, and the other essential information about a specific device that is used by the filter proxy 106 to make the content useable by the device. The device profile also provides essential information for building ML templates that may be referenced through an index or saved state information or by way of using a user profile for the given URI list as depicted in FIGS. 5 and 6.

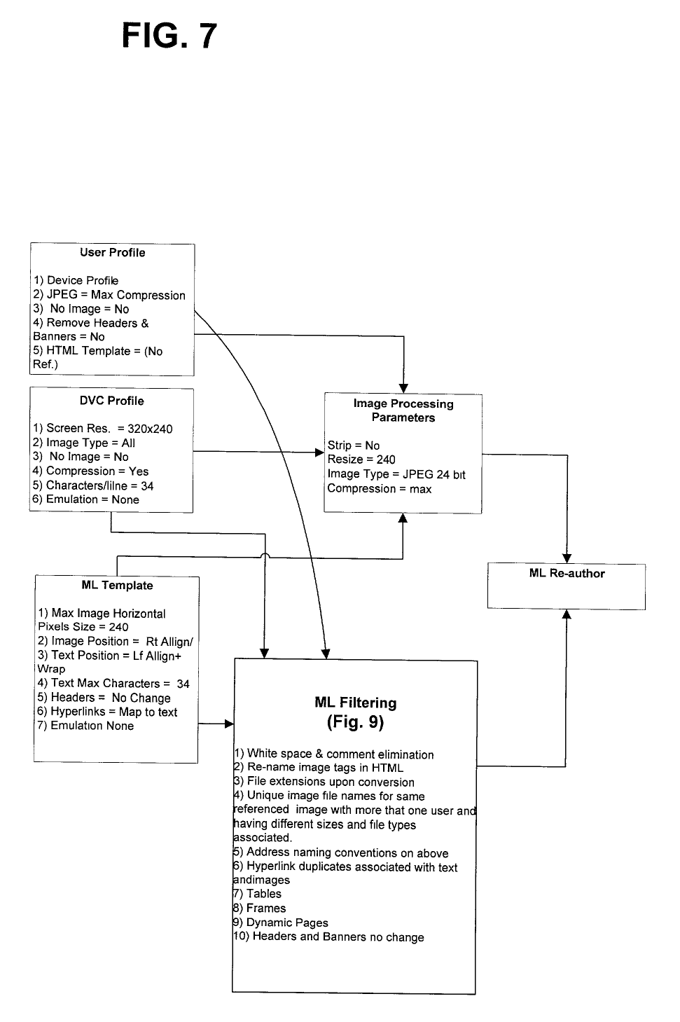

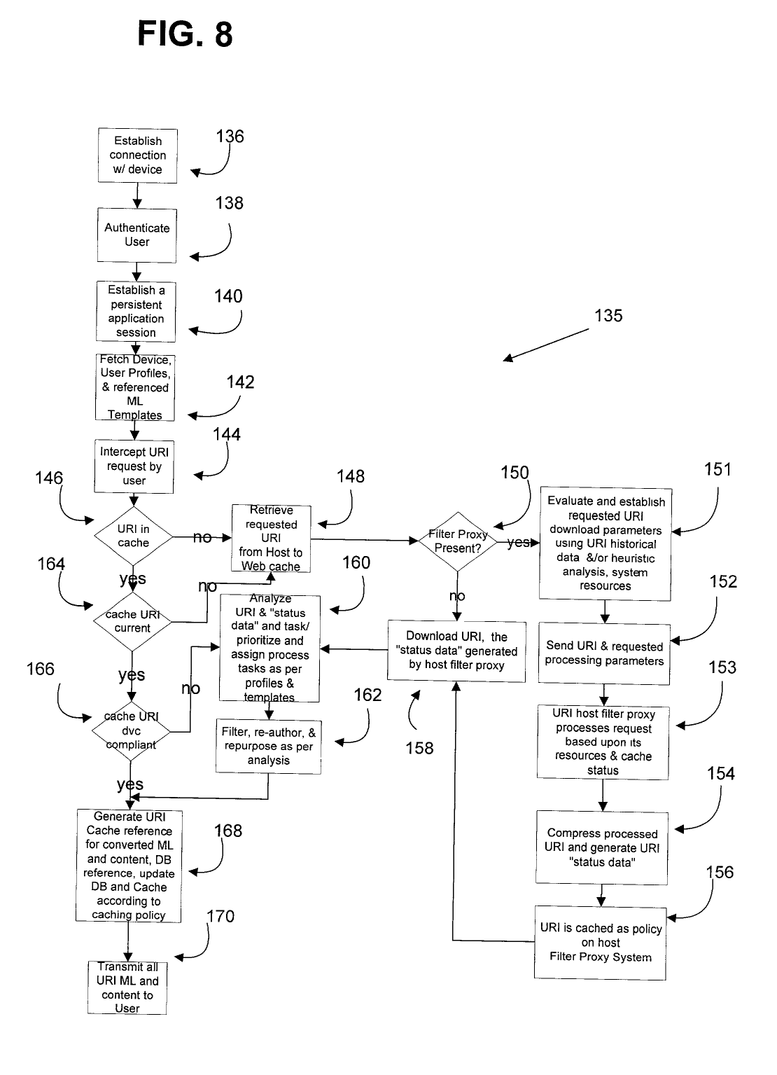

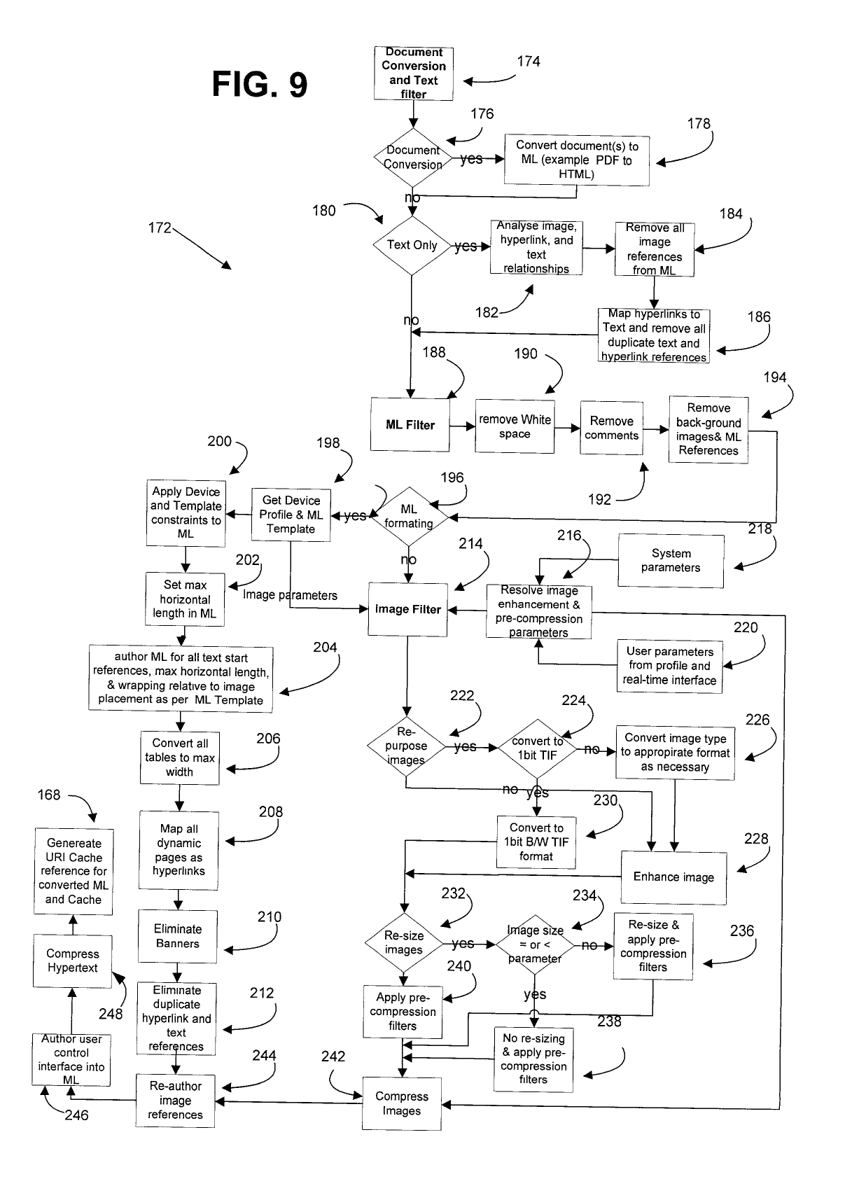

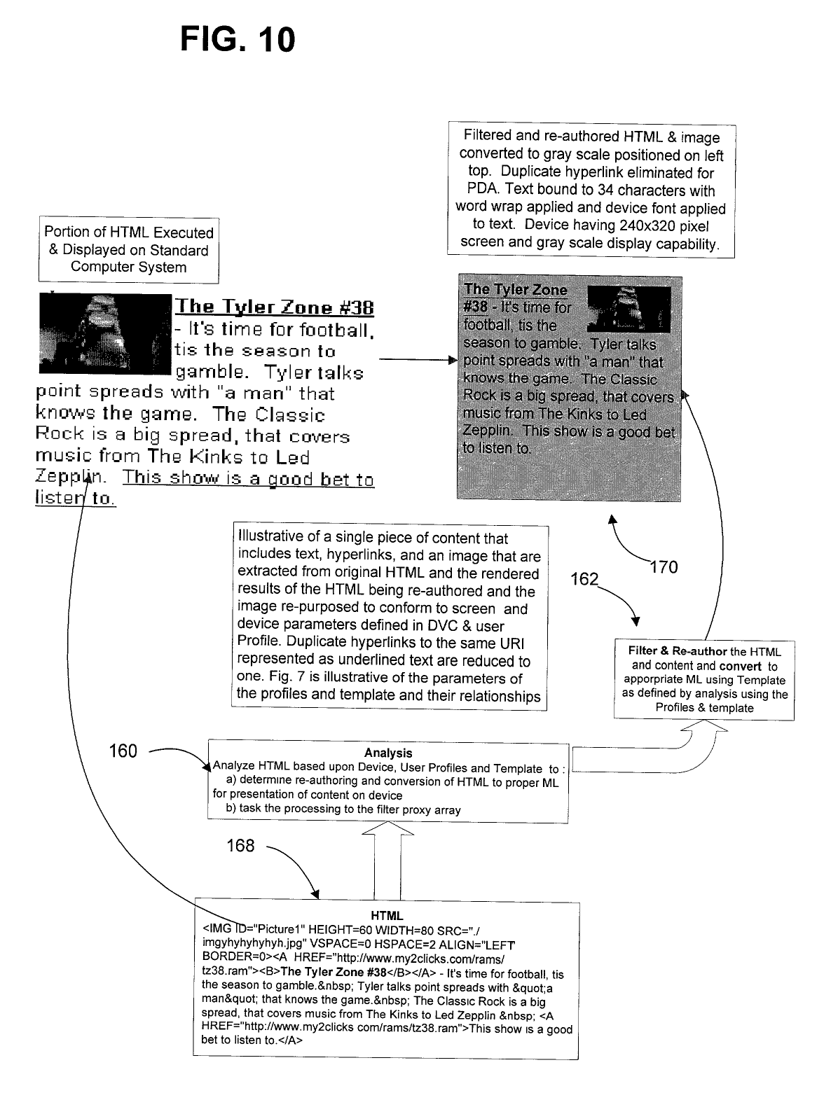

ML templates are device type dependent and original ML format dependent. ML templates provide formatting specifications optimized for a URI based upon its analysis by the filter proxy 106. ML templates include information, such as text wrapping, text justifying, locating images, mapping text to functionality, that are emulated by the filter proxy 106 on behalf of the device, and whether the content is dynamic and referenced by a hyperlink which determines if the content must be downloaded upon each new request of the URI even if the ML is resident in cache. FIG. 7 illustrates an example of relationships of the various elements of the databases 120 and generation of a template for formatting content to a specific device and user requirements.

In general, a user profile provides the user via a user interface additional control over content downloaded. The user profile may include: 1) elimination of image content or an image compression ratio applied, re-sizing parameter, and image format to be downloaded, 2) a list of URL's to which the a user wishes to restrict access, 3) password administration, and 4) user account information. Interfaces are provided to allow new device registration, administration, changing of passwords, access to accounting information, and “on-the-fly” access to elements that impact downloading of content. The last or previous user profile updated by the user may be set as a default, which is referenced and loaded for parameters at the time of login. FIG. 6 illustrates an example of some of the elements that compose the user profile. Each device, where applicable, may have a separate user content profile table and a user URI list table. The optional security and accounting databases may be aggregated or device dependent depending upon the user's relationship with a hosting system and its operational environment. The user content profile is used with the device profile to establish the rules for changing and formatting of the image(s) and other content for a device for any given request for information or communication with the filter proxy 106 and any other services offered on the host system. The user profile is not required for the filter proxy 106 to function and process URI and its content for the requesting device in a dynamic “on-the-fly” environment.

D. Caching Services

In one embodiment, caching is an integral component of the filter proxy process. The caching services provide high speed and immediate data availability to the various components of the filter proxy system 102.

Three exemplary types of caching services are shown in FIG. 2. The first type of caching is that the web caching server farm 108 provides caching for previously downloaded URI content and any device dependent changes made to the URI content. The second type of caching is that the caching retrieval server 110 retrieves URI at the time of the request for purposes of comparison with existing cached content and acts as an intermediate buffer and retrieval service to offload tasks from the filter proxy 106. The caching retrieval server 110 utilizes parameters established by the master browser 122 to communicate with another same filter proxy system 103 and accessing its cache over the network for download of requested URI that may already be formatted and compressed for the device thus reducing the bandwidth utilized between the two proxies and resources of the requesting filter proxy system 102. The state of the requested URI on the hosting filter proxy system 103 is determined so that the processing is done in a manner for most efficient use of available resources across the network. Distribution of the processing between the two communicating filter proxy systems is managed in such manner that the system is capable of balancing the processing, reducing bandwidth utilization, meeting the device and user content requirements, and retaining content functionality.

Exemplary statistics that impact how the URI is downloaded to the requesting filter proxy 106 may include number of current request for the URI page, if and what multiple devices have made a request for it, historical data that would show time of day load and request and finally the current load of the two filter proxies 102, 103 communicating. The processing parameters for the particular request are passed to the hosting filter proxy 103 where the re-purposing and compression of control code, text, and image content as per the rendering device and/or requestor specifications will be performed on behalf of the requesting filter proxy system 102 to reduce the bandwidth utilization between them and offload the required processing for making the content device compatible. Once it has been determined that the URI content is required, the URI content is moved to the web caching server farm 108.

The third type of caching is a transport protocol cache 118 used by the communications/gateway server 104 as shown in FIG. 1.

E. The Filter Proxy Process Steps and Functional Relations

The filter proxy 106 may be composed of a single or multiple physical processors on a single or multiple physical servers that work together to perform requested tasks “on-the-fly” at the time the request or requests are made.

Referring back to FIGS. 2 and 3, the filter proxy 106 includes the master browser 122 and one or more physical and logical filter proxy components, which can be formed into the filter proxy server array 124. FIG. 2 defines the relationships between the filter proxy 106 and the other services of the filter proxy system 102 as well as a task list for re-authoring, compressing, and/or re-purposing the ML and its referenced images and other content by the filter proxy server array 124. The task list will be further discussed in more detail in the following section.

Referring now to FIG. 8, one embodiment of a method of filter proxy process 135 according to the principles of the present invention is illustrated. The filter proxy process 135 includes the operations from connecting to a device to sending a re-formatted or filtered ML and its filter content to a requesting device. It is appreciated that the sequence or order of the filter proxy process can be altered without departing from the present invention.

As shown in FIG. 8, the filter proxy process 135 starts with an operation 136 of establishing a connection with a connected device by the master browser 122. Such connection is established upon receipt of appropriate connection information from the communications/gateway server. Next, the user's authentication is verified in an operation 138. The databases are queried in an operation 142 for the parameters required to support the user and device. Then, upon receipt of a URI request by the connected device, the URI is tagged and passed to an appropriate application session in an operation 144. Next, the master browser 122 queries the cache to determine if the URI is present in an operation 146 and if it is, i.e. the “yes” path, further determines if the cached URI is current in an operation 164 by downloading the meta tags and data that enable the filter proxy to discern the currency of the cached URI. If the cached URI is not current, i.e. the “no” path of the operation 146, the master browser 122 initiates a request to the URI host for download and directs such download to the web cache in an operation 148. Upon establishing communications with the host of the URI, the master browser 122 of the requesting filter proxy determines if a filter proxy system is present in an operation 150. If the filter proxy system is not present in the operation 150, i.e. the “no” path, the URI is downloaded in an operation 158 without change. The URI resource downloaded is evaluated and all its referenced content is then downloaded concurrently by initiating the same dialogue/query in the operation 158 with each URI content host. If the filter proxy system is present in the operation 150, i.e. the “yes” path, according to an operation 151, the requesting filter proxy evaluates and establishes the URI processing requirements it desires to be performed by the URI host. The operation 151 establishes parameters based upon current system resources and URI historical request statistics. In an operation 152, the requested URI and the requested processing parameters are passed to the URI host filter proxy system. In operation 153, the requested URI and its parameters are evaluated and processed by the URI host filter proxy in the same manner as the requesting filter proxy evaluates and processes a user's request. The process in the operation 153 is autonomous of the requested process requested and controlled by the URI host filter proxy system administration policy. In an operation 154, the host filter proxy generates process “status data”, which will be evaluated in an operation 160 of the requesting filter proxy to determine further filter processing necessary to fulfill the user and device requirements, and then compresses the URI content. The host filter proxy, in an operation 156, evaluates URI processed and caches it based upon its caching policy. In the operation 158, the “status data” and the processed and compressed URI are downloaded to the requesting filter proxy. The master browser 122 in the operation 160 analyzes the URI and any “status data” to determine filtering tasks to be performed in accordance with the profiles and template parameters, and system resources, prioritizes required filtering, and tasks filter processes to the filter proxy array. If the cached URI is determined to be current in an operation 164, then the device and user profiles, in an operation 166, determine what further filtering is required, if a template for the URI content is required and exists and used to locate the cached device formatted URI. If the cached URI is not device compliant, the master browser then analyzes the URI mark-up language in the operation 160 relative to the profiles and system resources and prioritizes and tasks filter processes to the filter proxy array.

The filter proxy re-authors, re-purposes, and/or compresses the URI Web page based on ML templates and the user and device profiles in an operation 162. Then, the filter proxy moves to an operation 168 to cache qualified converted ML and text format based on URI reference and device profile. Data that is retrieved by the filter proxy and marked as “user private” follows caching rules, e.g., if cached, data may only be retrieved by an authorized user. If the URI in cache is determined to be compliant with the device, in the operation 166, i.e. “yes” path, then the filter proxy moves to the operation 168 where all new compressed and re-authored ML are given a new reference name, and images and new ML are indexed to the URI in the appropriate databases for future quick retrieval, mapped to the cache and cached.

Finally, the processed ML and content are transmitted to the user in an operation 170.

F. Filter Proxy Content Processing

Referring now to FIG. 9, one embodiment of an operational process 172 of re-authoring, mapping, and conversion of the ML and the content of the filter proxy according to the present invention is illustrated in detail. It is appreciated that this embodiment illustrates the present invention as it is applied to mark-up language (ML) but is not limited to this form of control language. Furthermore, this embodiment is for illustrative purposes and does not restrict the content to text or static images but may include video, digital voice, and other types of digital content. Table 1 as discussed above illustrates the functions (e.g. a filter library) that may be performed to filter, re-author ML, re-purpose text, images, and/or other content, map functionality and hyperlinks, format the content for a device, and compress and convert the original ML, if necessary to another control language. It is appreciated that the list in Table 1 is for illustrative purposes and does not represent all task functions that are performed.

In FIG. 9, the process 172 starts with an operation 174 of document conversion and determines if text only will be delivered to the user. Special document formats may not be renderable on the device by its browser. The device and user profiles, which determine the device ML and rendering capacity, are used to determine whether a document must be converted in an operation 176 to the ML, whereupon the proper conversion filter, in an operation 178, is applied to convert it to appropriate ML. If no document conversion, in the operation 176, is required, i.e. the “no” path, the device and user profiles are further used to determine if URI mark-up language content is stripped except for only the text in an operation 180. Upon conversion of a document in the operation 178, further filtering may be applied in accordance with the device and user profiles to determine if only text is allowed in the operation 180. If text only, in the operation 180, is required, i.e. the “yes” path, the ML is analyzed in an operation 182 for content and ML relationships such that all image references, associated hyperlinks, and other content forms are removed in an operation 184, and duplicate text and hyperlinks are further edited from the original ML in an operation 186 to leave only the pertinent text. If text only is not a requirement in the operation 180, i.e. the “no” path, further ML filtering is performed in an operation 188.

The ML filter process 188 passes all ML to remove white spaces in an operation 190, any comment in an operation 192, un-needed background images in an operation 194, and other references embedded in the ML. Upon removing such data, it will not affect the functionality or alter any copyrighted content but reduce the overall size of the ML that must be downloaded by the user and so as to re-author ML and content according to the device and user specifications, referencing FIG. 7 as an example of parameter relationship. The re-formatting of the ML and textural content for rendering on the specific device is determined in an operation 196, and if required, i.e. the “yes” path, the device and template parameters are retrieved in an operation 198 and applied as constraints to the ML in an operation 200. The device and template parameters from the operation 198 are further applied to any image filtering that may occur in an operation 214. By applying ML constraints in the operation 200, the ML is analyzed for text string length and maximum width setting in an operation 202 that is used to re-author the text control ML in an operation 204 by setting parameters such as a start point, max horizontal length, wrapping and image placement. Then, the tables are analyzed, converted, and re-authored in an operation 206 using the same parameter set. Next, dynamic pages are mapped as hyperlinks in an operation 208 so as to reduce overhead on initial download. Banners are eliminated as necessary in an operation 210. Then, all duplicate hyperlink references and duplicates of text are removed in an operation 212 if not done so in the text only in the operation 180 “yes” path. The ML is ready for re-authoring of any required image references in an operation 244 upon completion of any image filtering in the operation 214.

The image filter operation 214 utilizes input parameters from the device profile and ML template in the operation 198 and the resolved enhancement and pre-compression parameters in an operation 216 that are determined in response to system resources available in an operation 218, such as bandwidth statistics provided by the communications/gateway server and filter processing resource statistics provided by the master browser. This allows to balance the system load and service the maximum number users and when user parameters are input in an operation 220.

If re-purposing of images is required in an operation 222, i.e. the “yes” path, images are re-purposed based upon the profiles. If such conversion is to be a 1 bit B/W in an operation 224, i.e. the “yes” path, the conversion is performed in an operation 230. Else, if the conversion is not Ibit in the operation 224, the conversion of all other formats, such as a GIF format to JPEG is performed in an operation 226. Then, image enhancement may be applied to correct and improve the image visual qualities in an operation 228. The conversion in the operation 226 and enhancement in the operation 228 may not necessarily both occur or may not necessarily occur in this order or are image format dependent.

If re-purposing of the images are not required, i.e. the “no” path of the operation 222, the images are enhanced in the operation 228 according to resolved parameters in the operation 216.

If re-sizing of the images is required, i.e. the “yes” path from an operation 232, the images resulting from the conversion operations 230 and 228 are resized according to profiles or system parameters. If the images to be resized are equal to or smaller than the re-sizing parameters in an operation 234, the image is not resized, and pre-compression filters may be applied in an operation 238 to retain quality and achieve higher compression rates and allowable by resolved parameters from the operation 216. If the image is larger than the re-size parameter, i.e. the “yes” path of the operation 234, the images are re-sized in an operation 236 by applying pre-compression filters to retain quality and achieve higher compression rates and allowable by resolved parameters from the operation 216. Images that are not re-sized as a result of the profiles from the operation 232, i.e. the “no” path, may be processed with pre-compression filters in an operation 240 to retain quality and achieve higher compression rates and allowable by parameters prioritization from the operation 216.

Upon completion of the pre-compression operations 240, 236, or 238 of images, compression is applied in an operation 242 according to the user profile and/or system parameters dependent on resolved parameters from the operation 216. Because each original image retains its original name in cache, and versions and/or revisions of the image may result from processing for different users and devices, a new name is given to each one, and the ML is re-authored with the new image reference in an operation 244, and it will also be used for referencing the image in cache at a later time. Then, the filter proxy may re-author the user control interface, in an operation 246, into the ML for real-time user control of image re-purposing and compression ratios that will affect quality of rendered image download time. Upon final re-authoring of the ML, the ML (hypertext and any associated text and other content excluding the images) may be compressed in an operation 248. Then, the filter proxy moves to the operation 168 where all newly compressed and re-authored ML are given a new reference name, images and new ML are indexed to the URI in the appropriate databases for future quick retrieval, mapped to the cache, and cached.

FIG. 10 illustrates an example of the results of the filter proxy system re-authoring the ML, re-purposing text and hyperlinks, images, and re-formatting the content for a PDA device. The source ML in FIG. 10 is of the form of HTML which depicts a portion of an original URI mark-up language page and its textual and image content as has been downloaded and is stored in cache in the operation 168 (FIG. 8). The master browser analyzes the URI mark-up language and content and tasks, prioritizes, and assigns the filtering processes to the filter proxy array 124 in accordance with the device and user profiles and template and cached content location in the operation 160 (FIG. 8). The ML and content filtering, re-authoring, and re-purposing are performed in accordance with the operation 162 to format the content to the device specifications and rendering capacity. The new ML is then transmitted and formatted properly for the device in the operation 170 (FIG. 8).

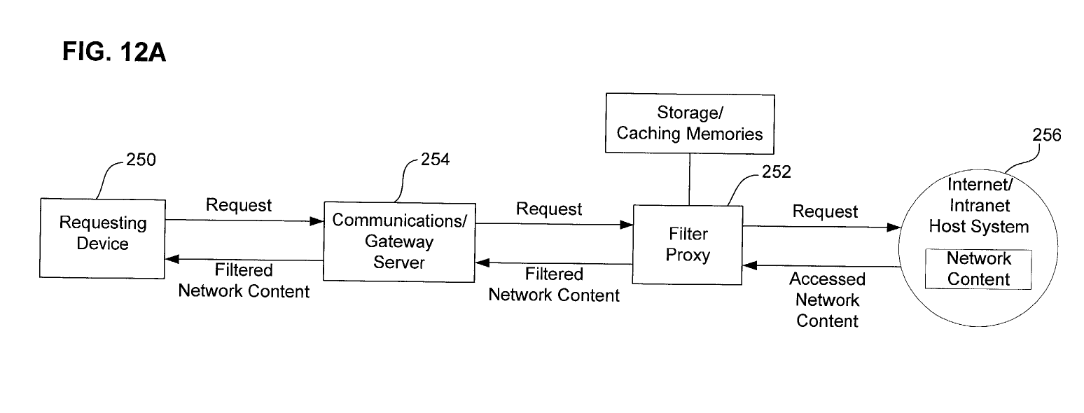

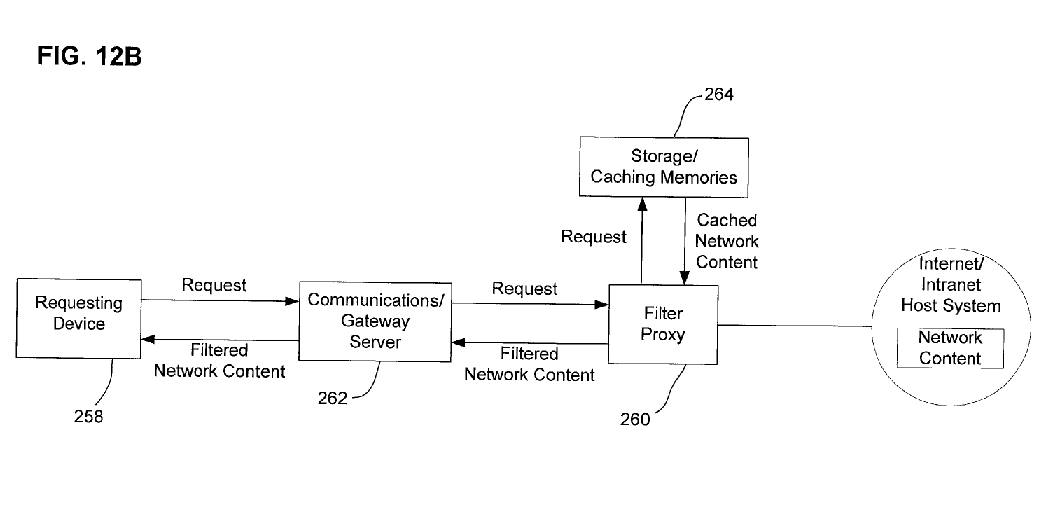

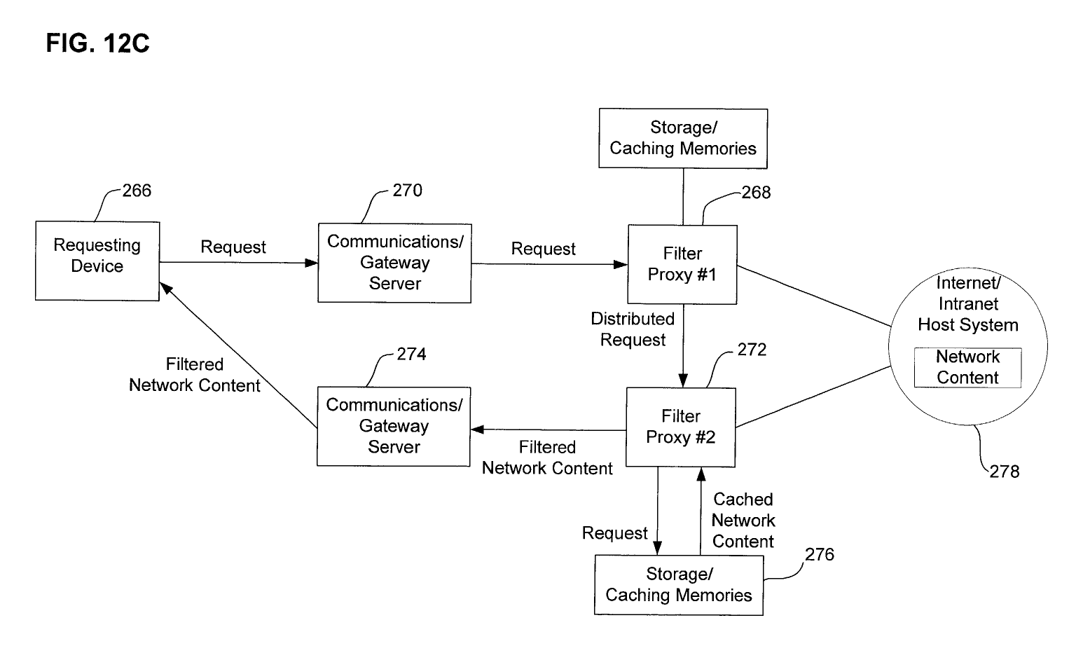

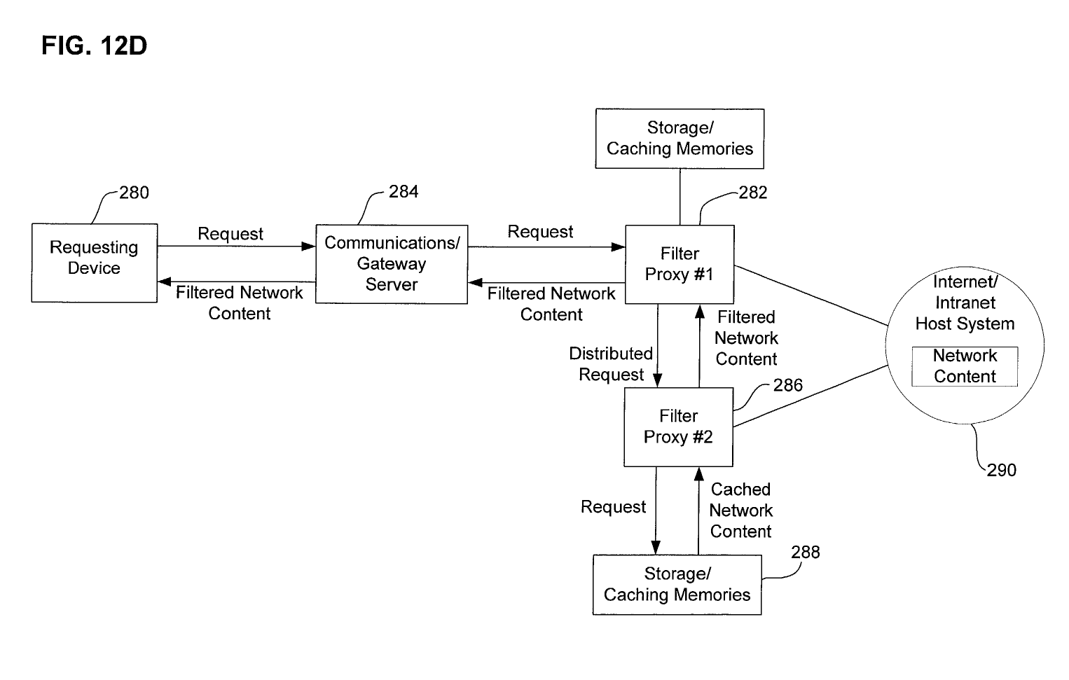

In general, a filter proxy method for requesting and transmitting network content in accordance with the present invention can be illustrated in FIGS. 12A-12D as exemplary embodiments. In FIG. 12A, a requesting device 250 sends a request for accessing the network content to a filter proxy 252 via a communications/gateway server 254. The filter proxy 252 fetches the requested network content from an Internet/Intranet host system 256 and filters, e.g. re-purposes, re-authors, and compresses, the network content according to a set of parameters, such as system, device, and user profiles/preferences, etc. The filters of the filter proxy 252 have been discussed above in detail. The filtered network content is then transmitted to a receiving device. The receiving device can be the requesting device or another device specified by the requesting device 250.

In FIG. 12B, a requesting device 258 sends a request for accessing the network content to a filter proxy 260 via a communications/gateway server 262. The filter proxy 260 retrieves the requested network content from its storage or caching memories 264 and filters, e.g. re-purposes, re-authors, and compresses, the network content according to a set of parameters, such as system, device, and user profiles/preferences, etc. The filters of the filter proxy 260 have been discussed above in detail. The filtered network content is then transmitted to a receiving device. The receiving device can be the requesting device or another device specified by the requesting device 258.

In FIG. 12C, a requesting device 266 sends a request for accessing the network content to a filter proxy 268 via a communications/gateway server 270. The filter proxy 268 distributes the filtering functions/processes to another filter proxy 272 along with a set of parameters, such as system, device, and user profiles/preferences. The filter proxy 272 retrieves the requested network content from its storage or caching memories 276 and filters, e.g. re-purposes, re-authors, and compresses, the network content according to the set of parameters. The filters of the filter proxy 272 have been discussed above in detail. The filtered network content is then transmitted from the filter proxy 272 to a receiving device via a communications/gateway server 274. The receiving device can be the requesting device or another device specified by the requesting device 266. It is appreciated that other embodiments can be used to implement the filter proxy method within the scope of the present invention. For example, in FIG. 12C, instead of retrieving the network content from its storage or caching memories 276, the filter proxy 272 fetches the network content from an Internet/Intranet host system 278. It is further appreciated that the communications/gateway servers 270, 274 can be integrated into one communications/gateway server within the scope of the present invention.

In FIG. 12D, a requesting device 280 sends a request for accessing the network content to a filter proxy 282 via a communications/gateway server 284. The filter proxy 282 distributes the filtering functions/processes to another filter proxy 286 along with a set of parameters, such as system, device, and user profiles/preferences. The filter proxy 286 retrieves the requested network content from its storage or caching memories 288 and filters, e.g. re-purposes, re-authors, and compresses, the network content according to the set of parameters. The filters of the filter proxy 286 have been discussed above in detail. The filtered network content is then transmitted from the filter proxy 286 back to the filter proxy 282 and then a receiving device via the communications/gateway server 284. The receiving device can be the requesting device 280 or another device specified by the requesting device 280. It is appreciated that other embodiments can be used to implement the filter proxy method within the scope of the present invention. For example, in FIG. 12D, instead of retrieving the network content from its storage or caching memories 288, the filter proxy 286 fetches the network content from an Internet/Intranet host system 290.

It is appreciated that the filter proxy method can also be implemented on an Internet/Intranet host system when the filter proxy distributes the filtering process to the Internet/Intranet host system based on resources available and capacity. It is further appreciated that the filter proxy method can also be implemented on a requesting or receiving device on the network when the filter proxy distributes the filtering process to the requesting or receiving device based on resources available and capacity.

Having described the present invention in the preferred embodiments, modifications and equivalents may occur to one skilled in the art. It is intended that such modifications and equivalents shall be included within the scope of the claims which are appended hereto.

What is claimed is:

1. A method for automatically accessing network content for a requesting device, comprising the steps of:
providing a filter proxy;
accessing the network content on behalf of the requesting device;
providing filtered network content according to a set of parameters; and
transmitting the filtered network content to a receiving device by the filter proxy.

2. The method in accordance with claim 1, further comprising a step of caching accessed network content.

3. The method in accordance with claim 1, further comprising a step of caching the filtered network content.

4. The method in accordance with claim 1, further comprising a step of filtering the accessed network content by the filter proxy according to the set of parameters, wherein the step of providing the filtered network content includes providing the filtered network content filtered by the filter proxy.

5. The method in accordance with claim 2, wherein the step of accessing the network content includes accessing the cached network content.

6. The method in accordance with claim 5, further comprising a step of filtering the accessed network content by the filter proxy according to the set of parameters, wherein the step of providing the filtered network content includes providing the filtered network content filtered by the filter proxy.

7. The method in accordance with claim 3, wherein the step of accessing the network content includes accessing the cached network content.

8. The method in accordance with claim 7, wherein the step of providing the filtered network content includes providing the filtered network content by the filter proxy.

9. The method in accordance with claim 1, further comprising a step of distributing filtering of the network content to a sec ond filter proxy according to the set of parameters.

10. The method in accordance with claim 1, wherein the receiving device is the requesting device.

11. The method in accordance with claim 4, wherein the step of filtering the network content includes a step of re-purposing an image.

12. The method in accordance with claim 11, wherein the step of filtering the network content includes a step of re-authoring a mark-up language (ML) of the image.

13. The method in accordance with claim 4, wherein the step of filtering the network content includes a step of compressing an image.

14. The method in accordance with claim 13, wherein the step of filtering the network content includes a step of re-authoring a mark-up language (ML) of the image.

15. The method in accordance with claim 4, wherein the step of filtering the network content includes a step of re-purposing text.

16. The method in accordance with claim 15, wherein the step of filtering the network content includes a step of re-authoring a mark-up language (ML) of the text.

17. The method in accordance with claim 4, wherein the step of filtering the network content includes a step of compressing text.

18. The method in accordance with claim 17, wherein the step of filtering the network content includes a step of re-authoring a mark-up language (ML) of the text.

19. The method in accordance with claim 4, wherein the step of filtering the network content includes a step of compressing a mark-up language (ML).

20. The method in accordance with claim 19, wherein the step of filtering the network content includes a step of re-authoring the compressed mark-up language (ML).

21. The method in accordance with claim 9, wherein the step of filtering the network content includes a step of re-purposing an image.

22. The method in accordance with claim 21, wherein the step of filtering the network content includes a step of re-authoring a mark-up language (ML) of the image.

23. The method in accordance with claim 9, wherein the step of filtering the network content includes a step of compressing an image.

24. The method in accordance with claim 23, wherein the step of filtering the network content includes a step of re-authoring a mark-up language (ML) of the image.

25. The method in accordance with claim 9, wherein the step of filtering the network content includes a step of re-purposing text.

26. The method in accordance with claim 25, wherein the step of filtering the network content includes a step of re-authoring a mark-up language (ML) of the text.

27. The method in accordance with claim 9, wherein the step of filtering the network content includes a step of compressing text.

28. The method in accordance with claim 27, wherein the step of filtering the network content includes a step of re-authoring a mark-up language (ML) of the text.

29. The method in accordance with claim 9, wherein the step of filtering the network content includes a step of compressing a mark-up language (ML).

30. The method in accordance with claim 29, wherein the step of filtering the network content includes a step of re-authoring the compressed mark-up language (ML).

31. The method in accordance with claim 1, wherein the set of parameters includes system and device profiles, user preference, and a template.

32. A filter proxy system for automatically accessing network content for a requesting device, comprising:
a communications/gateway server for communicating with the requesting device and a receiving device;
a filter proxy, coupled to the communications/gateway server, for accessing the network content on behalf of the requesting device, providing filtered network content according to a set of parameters, and transmitting the filtered network content to the receiving device via the communications/gateway server; and
a storage, coupled to the filter proxy, for storing the parameters.

33. The system in accordance with claim 32, further comprising a cache memory for caching the accessed network content.

34. The system in accordance with claim 32, further comprising a cache memory for caching the filtered network content.

35. The system in accordance with claim 32, wherein the accessed network content is filtered by the filter proxy according to the set of parameters.

36. The system in accordance with claim 32, further comprising a second filter proxy, the first filter proxy distributes filtering of the network content to the second filter proxy, wherein the second filter proxy provides the filtered network content according to the set of parameters.

37. The system in accordance with claim 36, wherein the provided network content is filtered by the second filter proxy.

38. The system in accordance with claim 32, wherein the receiving device is the requesting device.

39. The system in accordance with claim 35, wherein the filter proxy filtering the network content includes the filter proxy re-purposing an image.

40. The system in accordance with claim 39, wherein the filter proxy filtering the network content includes the filter proxy re-authoring a mark-up language (ML) of the image.

41. The system in accordance with claim 35, wherein the filter proxy filtering the network content includes the filter proxy compressing an image.

42. The system in accordance with claim 41, wherein the filter proxy filtering the network content includes the filter proxy re-authoring a mark-up language (ML) of the image.

43. The system in accordance with claim 35, wherein the filter proxy filtering the network content includes the filter proxy re-purposing text.

44. The system in accordance with claim 43, wherein the filter proxy filtering the network content includes the filter proxy re-authoring a mark-up language (ML) of the text.

45. The system in accordance with claim 35, wherein the filter proxy filtering the network content includes the filter proxy compressing text.

46. The system in accordance with claim 45, wherein the filter proxy filtering the network content includes the filter proxy re-authoring a mark-up language (ML) of the text.

47. The system in accordance with claim 35, wherein the filter proxy filtering the network content includes the filter proxy compressing a mark-up language (ML).

48. The system in accordance with claim 47, wherein the filter proxy filtering the network content includes the filter proxy re-authoring the compressed mark-up language (ML).

49. The system in accordance with claim 37, wherein the second filter proxy filtering the network content includes the second filter proxy re-purposing an image.

50. The system in accordance with claim 49, wherein the second filter proxy filtering the network content includes the second filter proxy re-authoring a mark-up language (ML) of the image.

51. The system in accordance with claim 37, wherein the second filter proxy filtering the network content includes the second filter proxy compressing an image.

52. The system in accordance with claim 51, wherein the second filter proxy filtering the network content includes the second filter proxy re-authoring a mark-up language (ML) of the image.

53. The system in accordance with claim 37, wherein the second filter proxy filtering the network content includes the second filter proxy re-purposing text.

54. The system in accordance with claim 53, wherein the second filter proxy filtering the network content includes the second filter proxy re-authoring a mark-up language (ML) of the text.

55. The system in accordance with claim 37, wherein the second filter proxy filtering the network content includes the second filter proxy compressing text.

56. The system in accordance with claim 55, wherein the second filter proxy filtering the network content includes the second filter proxy re-authoring a mark-up language (ML) of the text.

57. The system in accordance with claim 37, wherein the second filter proxy filtering the network content includes the second filter proxy compressing a mark-up language (ML).

58. The system in accordance with claim 57, wherein the second filter proxy filtering the network content includes the second filter proxy re-authoring the compressed mark-up language (ML).

59. The system in accordance with claim 32, wherein the set of parameters includes system and device profiles, user preference, and a template.

60. The system in accordance with claim 32, wherein the filter proxy further comprises:
a master browser for browsing the accessed network content; and
a filter proxy server array for processing a plurality of requests from at least one requesting device.

61. The system in accordance with claim 60, wherein the communication between the communications/gateway server is continuous.

62. The system in accordance with claim 36, wherein the first filter proxy provides the network content according to resources available and capacity, and the second filter proxy provides the network content according to the set of parameters on behalf of the first filter proxy.

63. The system in accordance with claim 59, wherein the user preference includes a user preferable format for re-purposing, re-authoring, and compressing the network content.

64. The system in accordance with claim 59, wherein the user preference is applied to multiple requesting devices that a user uses to access the network content.

65. The system in accordance with claim 63, wherein the requesting device includes a user interface to change the user preference.

66. The system in accordance with claim 65, wherein the filter proxy authors the user interface into a mark-up language of each page of the network content downloaded to the receiving device to provide a user real-time control of the preferable format of re-purposing, re-authoring, and compressing the downloaded network content.

67. The system in accordance with claim 66, wherein the user preference is stored in a user profile for future control upon establishing a new communication session between the requesting device and the filter proxy.

68. The system in accordance with claim 32, wherein the requesting device includes a client filter proxy for providing a custom transport protocol with the filter proxy.

69. The system in accordance with claim 68, wherein a continuous connection is maintained between the client filter proxy on the requesting device and the filter proxy.

70. The system in accordance with claim 68, wherein the client filter proxy on the requesting device receives streamed data from the filter proxy.

71. The system in accordance with claim 36, wherein the requesting device includes a client filter proxy for providing a custom transport protocol with the filter proxy and the second filter proxy.

72. The system in accordance with claim 71, wherein a continuous connection is maintained between the client filter proxy on the requesting device and the second filter proxy.

73. The system in accordance with claim 71, wherein the client filter proxy on the requesting device receives streamed data from the second filter proxy.

74. The system in accordance with claim 71, wherein a continuous connection is maintained among the client filter proxy on the requesting device, the filter proxy, and the second filter proxy.

75. The system in accordance with claim 71, wherein the client filter proxy on the requesting device receives streamed data from the second filter proxy and the filter proxy.
